(19) United States
(12) Patent Application Publication
(10) Pub. No.: US 2023/0072283 A1
(43) Pub. Date: Mar. 9, 2023

(54) ELECTROMAGNETIC FISHING BAIT DRIVE AND METHOD FOR CONTROLLING AN ELECTROMAGNETIC FISHING BAIT DRIVE

(71) Applicant: Edmund PÖTSCH, Königsbrunn (DE)

(72) Inventor: Edmund PÖTSCH, Königsbrunn (DE)

(21) Appl. No.: 17/798,109

(22) PCT Filed: Feb. 9, 2021
(86) PCT No.: PCT/DE2021/100128

§ 371 Date: Aug. 8, 2022

(30) Foreign Application Priority Data
Feb. 10, 2020 (DE) 10 2020 103 347.8
Mar. 10, 2020 (DE) 20 2020 101 329.7
Jan. 10, 2021 (DE) 20 2021 100073.2

(51) Int. Cl. A01K 85/00; H01F 7/02; H01F 7/20; H01F 7/06

(52) U.S. Cl. CPC A01K 85/1807; A01K 85/1893; H01F 7/02; H01F 7/20; H01F 7/064

(57) ABSTRACT

An electromagnetic fishing bait drive and a method for controlling an electromagnetic fishing bait drive are disclosed. The electromagnetic fishing bait drive comprises a waterproof sealable bait body (102) having a longitudinal axis of the bait body (Y) and an electromagnetic pendulum drive, wherein a first pole axis (P1) of an electromagnet (300) is substantially parallel to the longitudinal axis of the bait body (Y) and a second pole axis (P2) of the permanent magnet (313) is disposed at a defined angle to the first pole axis (P1).

### TECHNICAL FIELD

The present disclosure relates to an electromagnetic fishing bait drive, and to a method of controlling an electromagnetic fishing bait drive.

### BACKGROUND

A large number of artificial baits are used in fishing to replace the prohibited use of live bait fish. Furthermore, dead natural fishing baits are moved with an electromagnetic actuator to imitate movements of a live prey. The key is to offer the artificial fishing bait, or a dead natural fishing bait used for catching predatory fish moved as naturally as possible.

Prior art German patent application DE 10 2018 117 801 A1 discloses an electromagnetic pendulum drive having a permanent magnet movable relative to a self-movable artificial baitfish, the permanent magnet being adapted to move an artificial fishing bait body-side and tail-side. The orientation of the field coil of the electromagnet is such that a pole axis of its magnetic field is transverse to a longitudinal axis of the self-movable artificial baitfish, and the movable permanent magnet is movable transverse to the longitudinal axis of the self-movable artificial baitfish due to an application of magnetic force by a magnetic force field of the electromagnet.

The disclosed arrangement of electromagnetic components, particularly the electromagnetic coil, requires a sufficiently large space for movement to accommodate the excitation coil lying transverse to the longitudinal axis of the self-movable artificial baitfish, which requires a sufficiently large body shell. A miniaturized embodiment required for small body shells to accommodate smaller fishing baits, such as artificial or natural baitfish, reduces the available moment of motion and maximum possible tail fin deflection.

US 2017/0181 417 A1 discloses a motorized fishing bait having one or more pivoting devices on a drive unit. The drive unit causes the tail and/or head portions of the fishing bait to move and attract predatory fish. This movement is generally understood to mean that head and tail portions of the bait move from side to side to imitate a swimming fish or, alternatively, a fish in distress. The drive unit is powered by a power source to provide electrical power. A controller connected to a power source having at least one electromagnetic actuator motor or unspecified electromagnetic coil motor connected to the controller for converting the electrical power into mechanical power, and an articulated hinge coupled to the electromagnetic actuator motor or electromagnetic coil motor for converting the mechanical power into movement of the fishing bait. The disadvantage of this is that the electromagnetic actuator motor and the articulated hinge require a large amount of energy to be absorbed, and the arrangement produces unnatural twisting and mechanical flipping noises during movement, which a predatory fish can pick up via its sensitive lateral line organ and deter it. The electromagnetic coil motor is conceptually mentioned as an “electro-magnetic coil motor” and is suitable for implementing an electric motor, which is known to comprise rotating electromagnetic coils.

WO 2016 187 007 A1 describes a motion generating device having a propulsion operatively connected to a deflectable structure constructed and arranged to be inserted into the mouth of a baitfish. The propulsion and deflectable structure are adapted to cause a deflection of a portion of the baitfish of at least 5 degrees. A device comprising a housing having a movable portion and a driver that moves the movable portion relative to the housing is described. The housing, movable portion and propulsion are sized and shaped to at least partially fit within a baitfish. Further, the propulsion and movable portion, when positioned in the baitfish, move a first portion of the baitfish relative to a second portion of the baitfish.

The propulsion generates continuous or intermittent rotary motion to drive a mechanical linkage or eccentric drive element and generates linear motion as produced by a piston. In this regard, a propulsion may comprise one or more of an electric motor, electroactive polymers, piezoelectric materials, a hydraulic motor, gear parts, pistons, unspecified electromagnetic coils and magnetic materials, springs, eccentrically rotated pins, slots, yokes. Electromagnetic coils and magnetic materials are mentioned as part of the propulsion system, but only the use of these components in an electric motor or in an electromagnetic gearmotor is disclosed to the skilled person. The propulsion comprises an electric motor, in particular an electromagnetic gearmotor, coupled to an eccentric pin or a ball that is rotated about an axis to travel over a yoke or through a slot that is used to generate a lifting motion.

The disadvantages are that the electromagnetic motor and the eccentric mechanism require a large amount of space and energy, and that the arrangement generates unnatural turning and mechanical reversing noises during movement, which a predatory fish picks up via its sensitive lateral line organ and which can scare it off.

WO 2014 194 397 A1 describes a fishing bait suitable for self-generated movement in water to imitate the natural movement of live fish prey. The fishing bait comprises a waterproof bait body having a motor and a swing arm assembly connected to the bait body by a tail shaft driven by the motor to cause the swing arm assembly to swing. The propulsion described includes a coil positioned relative to a stationary magnet, wherein the coil oscillates back and forth in response to magnetic pole interactions between the coil and the magnet, which are alternately generated in the coil as defined by a controller.

A disadvantage is that the coil, which swings back and forth in the bait body above the stationary permanent magnet, mechanically hits a holder in its end position and generates switching noise, which a predatory fish picks up via its sensitive lateral line organ and which can scare it off. Further, the electrical joint between the moving coil and the controller requires a moving feed line, which is mechanically stressed by the continued mechanical movement of the coil and is therefore another source of noise and is additionally susceptible to failure due to material fatigue. The transverse coil requires a sufficiently large space for movement between the side walls of the bait body or a corresponding miniaturized embodiment to be accommodated in smaller fishing baits. This reduces the available moment of motion and the maximum possible tail fin deflection.

### SUMMARY

It is an object of the present disclosure to provide an effective electromagnetic fishing bait drive which does not have the disadvantages of the prior art and can be integrated in a space-saving and cost-effective manner even in small artificial or dead fishing baits, allows a propulsion as powerful as possible for the movement of an artificial or a dead fishing bait with a low energy demand and imitates a natural course of motion of a healthy or sick prey for the predatory fish to be caught which can be controlled or adjusted in a defined manner by the angler without emitting unnatural vibrations and allows the use of a conventional mounting of the fishing rod. It is further an object of the present invention to provide a method of controlling an electromagnetic fishing bait drive.

The problem is solved by an electromagnetic fishing bait drive comprising a bait body which can be closed in a watertight manner and has a longitudinal axis of the bait body. The electromagnetic fishing bait drive includes an electromagnetic pendulum actuator with an electric power source, an electronic control unit, an electromagnet comprising an excitation coil having a first pole axis, and a pendulum actuator comprising a permanent magnet having a second pole axis, and a pendulum lever. Due to a magnetic force field of the electromagnet the permanent magnet is movable transversely to the longitudinal axis of the bait body. The excitation coil is arranged with the first pole axis at an angle in the range of 0°+/−30° to the longitudinal axis of the bait body.

Alternatively, an electromagnetic fishing bait drive comprises a watertight sealable bait body having a longitudinal axis of the bait body and an electromagnetic pendulum drive comprising an electrical power source, an electronic control unit, an electromagnet comprising an excitation coil with a first pole axis and a pendulum actuator comprising a permanent magnet with a second pole axis and a pendulum lever. Due to a magnetic force field of the electromagnet the permanent magnet is movable transversely to the longitudinal axis of the bait body. The excitation coil is arranged with the first pole axis at an angle in the range of 90°+/−30° to the longitudinal axis of the bait body. The first pole axis (P1) is guided tail-side to the rear via at least one pole shoe or yoke of ferromagnetic material and forms a further first pole axis which is arranged to the longitudinal axis of the bait body at an angle in the range of 0°+/−30°, and the permanent magnet is arranged with the second pole axis to the longitudinal axis of the bait body within an angular range of 90°+/−40°.

A method of controlling an electromagnetic fishing bait drive comprising the steps of: providing the disclosed bait body of an electromagnetic fishing bait drive in a body shell of an artificial fishing bait or in a body shell of a dead natural fishing bait; attaching a connecting line to an angler to an attachment means of the bait body and/or the body shell; producing an electrical joint from an electromagnetic power source to electrical components of an electromagnetic pendulum drive; and releasing the body shell into a surrounding water.

For the purposes of this disclosure, a fishing bait is either an artificial fishing bait which is as close as possible to a natural replica of a natural prey, preferably a fish, or a dead natural prey in the form of a dead natural fishing bait, preferably a dead fish. Natural prey may also include other animals, such as a frog, toad, or mouse, or other prey or insects.

By a movement to be driven by an electromagnetic fishing bait drive in the sense of the invention, it is understood that the body and/or tail part of the artificial fishing bait or dead natural fishing bait move from side to side along its longitudinal axis to imitate a swimming or dying fish or, alternatively, other natural prey in distress. Advantageously, the movement of the electromagnetic fishing bait drive may additionally produce a force effect propelling the fishing bait forward.

The electromagnetic fishing bait drive comprises a bait body and an electromagnetic pendulum drive.

For purposes of the present disclosure, the bait body comprises a watertightly sealed submersible body that is integratable into either the artificial fishing bait or the dead natural fishing bait. The bait body has a front end that is integratable in the artificial fishing bait or in the dead natural fishing bait in a head-oriented manner. The bait body further comprises a lateral profile forming the side walls of the bait body. Preferably, the bait body is cylindrically shaped and has a tubular cross-sectional profile that is round or oval in shape. However, other cross-sectional profiles are also applicable, for example a square, rectangular, polygonal, kidney-shaped tubular cross-section or a cross-section with any circumferentially tubular closed profile. Advantageously, as an alternative to a cross-section that is constant along a longitudinal axis of the bait body Y, the bait body has a cross-section that varies along the longitudinal axis of the bait body Y, for example, an oval, teardrop, or cigar-shaped profile to replicate and support the streamline shape of an artificial fishing bait or a dead natural fishing bait. The bait body has a rear end that can be integrated into the artificial fishing bait or dead natural fishing bait in a tail-side orientation. The bait body is integratable elongated in the artificial fishing bait or in the dead natural fishing bait. The aspect ratio between the length of the bait body and the maximum width of the bait body is greater than 1, in particular greater than 2 and is preferably greater than 5. The longitudinal axis of the bait body Y extends centrally in the bait body through the front end and the rear end of the bait body, respectively.

For purposes of this application, a body shell of the fishing bait comprises the coating body of the artificial fishing bait or the body of the dead natural fishing bait.

The electromagnetic fishing bait drive may alternatively be implemented, when used in the artificial fishing bait, by integrating the components of the electromagnetic fishing bait drive into the body shell of the artificial fishing bait in a watertight manner. In this case, the bait body comprises the body shell of the artificial fishing bait.

The electromagnetic pendulum drive comprises an electric power source, an electromagnet comprising an excitation coil, an electronic control unit and a pendulum actuator comprising a permanent magnet and a pendulum lever on which the permanent magnet is mounted in a pendulum radius Rp around a pendulum bearing and generates an oscillating movement of the tail and/or the body of the dead natural fishing bait or the artificial fishing bait with a defined deflection sm transversely to the longitudinal axis of the bait body Y. Advantageously, a plurality of permanent magnets can be arranged in mutually attractive stacked arrangement in order to adapt the geometrical dimensions of the permanent magnet and/or to change the magnetic force of the permanent magnet. It is particularly advantageous if one or more stacked cube-shaped permanent magnets, each with an edge length of about 5 mm, a remanence of 1.3T to 1.4T and a coercive force of 860 kA/m to 955 kA/m and of >=955 kA/m, are used. Subsequently, the term permanent magnet is also used for stacked permanent magnets. However, single or multiple permanent magnets with largely different body shapes, dimensions and magnetic data can also be used. Thus, depending on the size of the fishing bait to be moved, edge lengths or cylinder lengths of 1 mm up to 50 mm per permanent magnet or diameters of 1 mm up to 50 mm can be considered. A permanent magnet is advantageously cube-shaped, cuboid, disc-shaped, cylindrical, rod-shaped, concave or convex barrel-shaped or prism-shaped.

In a predominantly chosen arrangement of a cube-, cuboid-, or cylinder-shaped permanent magnet according to the invention, the effective magnetic force component of the permanent magnet emanates from the edge of the permanent magnet closest to the electromagnet as a function of the deflection sm.

For the purposes of the present disclosure, a first pole axis P1 is the axis through the excitation coil which joins the two opposite magnetic poles of the excitation coil when the excitation current is flowing. The first pole axis P1 runs in the excitation coil in the direct line connecting its poles.

In a first alternative embodiment, the first pole axis P1 to the longitudinal axis of the bait body Y preferably has an angle in the range of 0°+/−30°, preferably 0°+/−10°, in particular in the range of 0°+/5° and therefore runs substantially parallel to the longitudinal axis of the bait body Y. The excitation coil with the first pole axis P1 is arranged at an angle in the range of 0°+/−30° to the longitudinal axis of the bait body Y.

A coil length LC in the sense of the present invention is the length of the coil winding of the excitation coil in the axial direction along the first pole axis P1.

A coil height HC in the sense of the present invention is the height of the coil winding of the excitation coil in radial direction along the first pole axis P1.

Advantageously, in the first alternative embodiment, the excitation coil has a coil length or winding length LC of from 1 mm to 50 mm, preferably from 3 mm to 30 mm, in particular from 5 mm to 20 mm, and a coil height HC of from 0.5 mm to 20 mm, preferably from 1 mm to 10 mm, in particular from 2 mm to 4 mm.

A wire thickness DW of the winding wire for realizing the excitation coil has a diameter in the range of DW=0.01 mm to 0.5 mm, preferably from DW=0.03 mm to DW=0.15 mm, in particular from 0.05 mm to 0.1 mm, using fine wire or ultrafine wire.

In order to achieve a high magnetic induction with a low mass of the excitation coil and a low excitation current ie, in a second alternative embodiment a flat and wide coil with a low coil length LC and a comparatively high winding height HC can be realized. In this case, the coil length LC has a defined ratio to the coil height HC.

Using fine wire or ultrafine wire, a wire thickness DW of the winding wire for realizing the excitation coil has a diameter in the range from DW=0.01 mm to 0.25 mm, preferably from DW=0.01 mm to DW=0.15 mm, in particular from 0.05 mm to 0.1 mm.

Advantageously, in the second alternative embodiment, the excitation coil has a coil length or winding length LC of from 0.1 mm to 15 mm, preferably from 0.3 mm to 10 mm, in particular from 1 mm and 4 mm. Furthermore, the excitation coil has a coil height or winding height HC of from 0.5 mm to 60 mm, preferably from 1 mm to 10 mm, in particular from 2 mm to 5 mm. Furthermore, the excitation coil has a ratio of coil height to coil length HC/LC of from 1 to 60, preferably from 1.5 to 20, in particular from 2 to 10.

Even by using a flat coil with a small winding length LC and a relatively large winding height HC, a high magnetic induction and thus a high magnetic force effect can be generated with a low total mass of the excitation coil. Since an acceleration of the fishing bait achievable by the fishing bait drive with a=F/m is inversely proportional to the mass of the fishing bait and the mass of the excitation coil has a high proportion of the total mass of the fishing bait drive, the synergy of the selected parameters of the wire diameter DW, the coil length LC and the coil height HC is of great importance for an achievable movement effect by the fishing bait drive.

Thereby, depending on the selected size ratios of the excitation coil in an embodiment according to the second alternative embodiment, it may be advantageous to arrange the first pole axis P1 transverse to the longitudinal axis of the bait body Y in order to optimally utilize the volume of a fishing bait that is oval in height cross-section. The coil body can have a circular, oval, rectangular or other course along a turn, in order to make the coil body optimally fixed to fit into the bait body while utilizing the available volume.

Advantageously, several such coils can be wound on a common core and the windings can be cascaded and can thus enhance the achievable movement effect of the fishing bait while making favorable use of the available volume in the fishing bait.

Advantageously, in the case of cascaded coils, a magnetic tap can be provided between the coils so as to form an E-shaped pole shoe or yoke.

In the second alternative embodiment, the first pole axis P1 is guided to the rear via at least one pole shoe or yoke of ferromagnetic material on the tail-side and forms a further first pole axis P1′ of the pole shoe or yoke of ferromagnetic material, which preferably has an angle in the range of 0°+/−30°, preferably 0°+/−10°, in particular in the range of 0°+/5°, to the longitudinal axis of the bait body Y and therefore runs essentially parallel to the longitudinal axis of the bait body Y.

The further first pole axis P1′ in the second embodiment is arranged at an angle in the range of 0°+/−30° to the longitudinal axis of the bait body Y, like the first pole axis P1 in the first embodiment.

Advantageously, further optionally also in this alternative embodiment of the second embodiment, the opposite pole of the electromagnet can be guided via a pole shoe or yoke of ferromagnetic material from the opposite pole of the core of ferromagnetic material as pole shoe or yoke to the rear to the permanent magnet, where the two ends of the pole shoe or yoke form an air gap to the permanent magnet.

A second pole axis P2 in the sense of the present invention is the axis through the permanent magnet which connects the two opposite magnetic poles of the permanent magnet. The second pole axis P2 runs in the permanent magnet in the direct connecting line of its poles.

In one embodiment of each of the first or second embodiments, the pendulum actuator is arranged with respect to the longitudinal axis of the bait body such that the second pole axis P2 has a defined angle to the longitudinal axis of the bait body Y, preferably an angle of 90° or an angle in an angular range of 90°+/−40°, in particular of 90°+/−25°.

The angular range of 90°+/−40° supports the deflection of a tail fin required for particularly fast fin propulsion, while the angular range of 90°+/−25° represents the range of usual effective fin movement during a forward movement, and another advantageous range of 90°+/−15° comprises, in addition to the range of usual fin movement during a forward movement, the range of typical movements of a sick or the natural prey in distress.

In these embodiments, the permanent magnet is arranged with the second pole axis P2 to the longitudinal axis of the bait body Y within an angular range of 90°+/−40°.

In another embodiment of the first alternative embodiment, the second pole axis P2 runs within a defined angular range of 0°+/−40° to the longitudinal axis of the bait body Y, preferably of 0°+/−25° to the longitudinal axis of the bait body Y. The angular range of 0°+/−40° to the longitudinal axis of the bait body Y supports the tail fin deflection required for a particularly fast fin propulsion, while the angular range of 0°+/−25° to the longitudinal axis of the bait body Y represents the range of the usual effective fin movement during a forward movement, and another advantageous range of 0°+/−15° to the longitudinal axis of the bait body Y comprises, in addition to the range of the usual fin movement during a forward movement, the range of the typical movements of a sick or the natural prey in distress. In this embodiment, the permanent magnet is arranged with the second pole axis P2 to the longitudinal axis of the bait body Y within an angular range of 0°+/−40°.

An initial position of the pendulum lever with respect to the longitudinal axis Y of the bait body in which no excitation of the electromagnet takes place is subsequently referred to as a zero position.

In an embodiment of the first alternative embodiment, the permanent magnet is arranged with the second pole axis P2 to the longitudinal axis of the bait body Y within an angular range of 0°+/−40° and intersects the projection of the first pole axis in the zero position of the pendulum lever or the further pole axis has a distance of maximum 5 mm from the second pole axis at the intersection of the projection of the pole axes (P1, P2) on each other.

In both the first embodiment and the second alternative embodiment, the first pole axis P1 or the further first pole axis P1′ preferably intersects with the second pole axis P2 to exert a force effect. Alternatively, the first pole axis P1 or the further first pole axis P1′ has a distance of at most 5 mm, preferably at most 2 mm, from the second pole axis P2 at the point of intersection of the projection of the pole axes onto one another. The first pole axis P1 or the further first pole axis P1′ intersects the second pole axis P2 in the zero position of the pendulum lever, or the first pole axis P1 or the further first pole axis P1′ has a distance of at most 5 mm from the second pole axis P2 at the point of intersection of the projection of the pole axes P1, P2 onto one another.

In the first alternative embodiment, the excitation coil of the electromagnet is arranged in the bait body in such a way that the first pole axis P1 is essentially parallel or in an angular range of 0°+/−30°, preferably of 0°+/−10°, in particular of 0°+/−5° to the longitudinal axis of the bait body. Thus, advantageously, a winding of the excitation coil of the electromagnet can be embodied along and around the longitudinal axis of the bait body, allowing an optimal utilization of the available volume inside the bait body even in case of a narrow bait body. Thus, even with small artificial fishing baits or dead natural fishing baits, as many turns of the excitation coil as possible can be accommodated in a small space. The force effect that can be generated by the electromagnet is proportional to the product of the excitation current ie and the number of turns N of the excitation coil. Thus, by increasing the number of turns of the excitation coil that can be accommodated per unit volume of the bait body, the excitation current ie can be reduced while the force effect remains the same, thus decreasing the charge drawn from the electrical power source. As a result, the electromagnetic fishing bait drive advantageously achieves a longer running time of the electromagnetic fishing bait drive with smaller dimensions of the electric power source.

The control of the electromagnet is particularly advantageous with alternating polarity, comprising an electrically bipolar AC voltage as the control voltage ue at the excitation coil and a bipolar AC current as the excitation current ie through the excitation coil of the electromagnet. The AC voltage and the AC current can have symmetrical signal sequences in the positive and negative directions, i.e. the integrals over time in the positive direction are equal to the integrals over time in the negative direction.

Alternatively, the AC voltage or AC current can have an asymmetrical signal sequence in the positive and negative directions, i.e., for example, the integrals over time in the positive direction are not equal to the integrals over time in the negative direction. Asymmetrical control can be used advantageously, for example, in the case of a propulsion used for the locomotion of the bait body for direction control or also for simulating a motion sequence of a sick prey animal.

Optionally and particularly advantageously, the excitation coil of the electromagnet additionally comprises a core of ferromagnetic material for amplifying the magnetic effect of the electromagnet. Due to its high magnetic conductivity, the core of ferromagnetic material concentrates the magnetic field lines of the excitation coil and thus amplifies the magnetic force in the air gap of the electromagnet.

In an advantageous embodiment of the first alternative embodiment, a central core of ferromagnetic material is arranged inside the excitation coil and is led via ferromagnetic material outside past the excitation coil from a first pole end of the central core of ferromagnetic material to a second pole end of the central core of ferromagnetic material, and a pole shoe or yoke of ferromagnetic material is formed which at the second pole end of the central core of ferromagnetic material has an air gap to the central core of ferromagnetic material in which the permanent magnet is movably arranged in such a way that the projection of the first pole axis P1 through the excitation coil and the second pole axis P2 through the permanent magnet intersect in at least one position at a defined angle.

The ferromagnetic material passing outside the excitation coil forms a pole shoe or yoke of ferromagnetic material which guides the magnetic counter pole of the central core to the permanent magnet, in whose air gap it moves and thus generates the drive torque for the tail fin via the pendulum lever and the pendulum bearing.

The pole shoe or yoke made of ferromagnetic material is advantageously U-shaped or E-shaped and/or at least partially pot-shaped. The pole shoe or yoke of ferromagnetic material may alternatively be formed completely pot-shaped. In the case of a partially or fully pot-shaped pole shoe or yoke, the pole shoe or yoke has a bottom of ferromagnetic material at the first pole end of the core of ferromagnetic material and leads tubularly as a cylinder past the outside of the excitation coil to the second pole end of the central core of ferromagnetic material where it forms an air gap to the central core of ferromagnetic material in which the permanent magnet is movably arranged in such a way that the projection of the first pole axis P1 through the excitation coil and the second pole axis P2 through the permanent magnet intersect in at least one position at a defined angle.

Particularly advantageously, the pot-shaped pole shoe or yoke of ferromagnetic material is cut out at the second pole end of the central core to match the shape of the permanent magnet and forms as homogeneous an air gap as possible with the edge of the permanent magnet.

This advantageously strengthens the attraction generated by the permanent magnet because its force acts on the central core and on the pole shoe or yoke of ferromagnetic material and, at the same time, the magnetic field or the magnetic flux density for reversing is strengthened by the pole shoe or yoke of ferromagnetic material.

In a particularly advantageous embodiment, the pole shoe or yoke of ferromagnetic material is formed U-shaped, E-shaped and/or at least partially pot-shaped.

In both alternative embodiments, the pendulum radius Rp is advantageously selected so that, when the core of ferromagnetic material is used, a minimum critical air gap hE to the core of ferromagnetic material results with an additional magnetic force component of the permanent magnet on the core of ferromagnetic material when the pendulum lever is in a nominal end position smE. This results in a maximum force effect Fm in the end position and a stop-free and therefore noise-free limitation of the deflection sm takes place in the end position because the attraction between the permanent magnet and the core of ferromagnetic material reaches a critical maximum in the end position.

An elastic stop can optionally be provided to limit the pendulum swing. The maximum is critical because at this value compensation of the magnetic field and thus reversal of the polarity of the movement due to the excitation of the electromagnet is still possible. If the radius Rp or the air gap h is too small, there is a risk that the permanent magnet will no longer be able to move away from the core of ferromagnetic material of the electromagnet. In this case, therefore, the distance of the pendulum bearing from the electromagnet L must be increased, whereby magnetic force and therefore moment of motion are lost.

Due to the advantageous arrangement with a core of ferromagnetic material and a pole shoe or yoke of ferromagnetic material, on the one hand the high magnetic holding force of the permanent magnet is used to generate a high moment of motion in synergy with the compensating effect of the electromagnetic force field of the electromagnet, in order to effect an energy-saving compensation of the magnetic field with the lowest possible excitation current and thus energy-saving with regard to the entrained power source and to initiate an energy-saving reversing of the pendulum actuator from one end position to the other end position.

The power source, the excitation coil of the electromagnet and the electronic control unit are integrated inside the waterproof bait body. The permanent magnet can be located inside the bait body or outside the bait body. Advantageously, in both cases, no mechanical joint is arranged between the electromagnet and the permanent magnet to transmit a force. The power transmission and the generation of the pendulum motion are effected by a magnetic force field.

The electromagnetic pendulum drive operates contactlessly without any significant mechanical friction of the driving elements and can be operated with elastic stops or preferably without stops and is therefore practically noiseless, which is an essential feature for successful use in catching.

The excitation coil comprises a coil with N windings, through which an alternating excitation current ie flows after applying a bipolar voltage ue, thereby generating a magnetic field with alternating polarity.

The magnetic force in an air gap h of a magnetic circuit of the magnetic field is considered proportional according to the following relation

Fm˜K*(ie*N/h)²,

where K represents a constant which comprises the magnetic properties of the materials used and the geometrical structure of the magnetic circuit and ie is the excitation current flowing in the excitation coil and N is the number of windings of the excitation coil.

An elastic return element is optionally arranged on the pendulum lever, which exerts a restoring force Fr of the pendulum lever in the direction of the zero position.

Advantageously, the pendulum bearing of the pendulum lever comprises the optional elastic return element, which exerts a restoring force Fr of the pendulum lever in the direction of the zero position without excitation current ie or with low excitation current ie in the excitation coil, thereby supporting or damping the movements of the pendulum lever. The damping restoring force absorbs kinetic energy from the electromagnetic fishing bait drive and reduces the moment of motion available to move the fishing bait. The return element's restoring force is therefore reduced as much as possible to producing a damping effect. Since damping and a restoring force proportional to speed relative to fin movement are generated during movement in the water, a return element and damping can optionally be omitted. The electromagnet transfers electromagnetic kinetic energy from the moving tail fin, which is damped by the surrounding water, when the fishing bait is deployed in the surrounding water, in part either through the bait body to the body shell of the fishing bait or directly to the body shell of the fishing bait. Advantageously, the body shell comprises fins at the top and bottom of the body shell to stabilize the lateral transverse motion of the body shell to a defined extent, which, together with the forward fin propulsion of the tail fin, enables a realistic conversion of the moment of motion of the electromagnetic fishing bait drive into a sequence of motion of the forward streamlined portion of the body shell to the transition area of the tail fin relative to the motion of the transition area to the tail fin and the tail fin. This creates a natural sequence of movement in which the anterior streamlined portion of the body shell to the tail fin transition area moves slightly and in opposition to the tail fin. This pattern of movement simulates the natural pattern of meandering movement typical of fish. The elastic return element comprises, for example, an elastomer, a rubber or a silicone and/or one or more permanently elastic springs made of metal or of plastic. The return element may be provided, for example, in a passage of the pendulum lever through the body shell of the fishing bait. In addition, a force of a passing water acting on the tail fin may cause a dynamic restoring force Fr with respect to the body shell of the artificial fishing bait or with respect to the body of the dead natural fishing bait, which is advantageously used with respect to the bait body in addition to restoring the pendulum lever.

Advantageously, the material of the resilient body shell and the tail fin transition area itself comprises the pendulum lever, eliminating the need for a separate pendulum lever. Further advantageously, the permanent magnet may be located within the body shell, the tail fin transition area, or within the tail fin.

In the case of the arrangement of a separate pendulum lever, this preferably comprises a springy material or an elastic material with a higher modulus of elasticity or a harder spring constant than that of the selected material of the tail fin and/or the material of the surrounding shell of the artificial fishing bait or the body of the dead natural fishing bait, respectively whereby the tail fin performs a trailing elastic power transmission with the bionic effect of a backward momentum transfer, a so-called fin propulsion, and thus via a so-called jet from the propulsion to the surrounding water. To be able to cause this effect, the synergy between the tail fin and the powerful propulsion according to the invention is required with a moment of motion generated by the dynamic air gap of the device according to the invention. The increase in moment of motion associated with increasing deflection sm of the pendulum lever effectively supports fin propulsion because the moment of motion increases exponentially until the end point of pendulum swing is reached and is instantaneously arrested at the end point of pendulum swing until reversing in the opposite direction occurs. This advantageously creates counter-rotating water vortices, so-called discontinuous jets, against which the tail fin repels during the counter-movement, thus creating a natural forward movement of the fishing bait.

This results in a direct natural movement of the artificial fishing bait or the dead natural fishing bait without unnatural mechanical vibrations due to rotary motion, commutation, bearing of a drive motor or from a gearbox, or from an eccentric mechanism or the like. The propulsion is largely noiseless and, when the tail fin moves in the water, emits the same vibrations as a living fish in its natural movement situations, from standing in the water to fleeing or moving in an injured or sick state.

An air gap h in the sense of the present invention is, in both alternative embodiments of the invention, the shortest distance between the permanent magnet of the permanent magnet pendulum actuator and the nearest pole of the electromagnet of the electromagnetic pendulum drive. A dynamic air gap is the function of the air gap during a movement of the permanent magnet pendulum actuator as a function of the deflection sm of the pendulum lever from its rest position.

An air gap h is arranged between the electromagnet and the permanent magnet, the air gap h becoming smaller when the pendulum lever is deflected as a function of the deflection of the pendulum lever from its zero position, reaching a minimum in an end position and becoming larger when an end position is exceeded.

The air gap h advantageously varies in the range between 20 mm and 0.01 mm, in particular between 5 mm and 0.05 mm and preferably between 2 mm and 0.5 mm.

The smaller the air gap h is selected in synergy with the pendulum radius, the elastic and dynamic restoring torque, the number of windings N and the magnitude of the excitation current ie, the greater the moment of motion of the permanent magnet pendulum actuator that can be achieved in this case and thus the moment of motion of the electromagnetic fishing bait drive.

The artificial fishing bait is a replica as close as possible to the natural prey, especially a fish. It comprises the body shell, which coats the bait body. The body shell of the artificial fishing bait advantageously comprises an elastic material such as plastic, in particular elastomers, rubber or silicone, with a defined modulus of elasticity in the range from 0.5 MPa to 100 MPa, or a Shore A hardness to DIN ISO 7619-1 in the range from 50 to 95 Shore 00 or from 10 Shore A to 90 Shore A, preferably in the range from 10 Shore A to 60 Shore A.

In dead natural fishing bait, the dead prey animal or dead prey fish forms the body shell.

The permanent magnet can be located inside the bait body. In this case, the pendulum lever is mounted inside the bait body or on its rear outer wall and is moved back and forth contactlessly by the changing magnetic field of the excitation coil. In this case, the permanent magnet pendulum actuator is carried out of the rear end of the bait body in a movable manner and sealed against water ingress, and passes into the tail fin, which it can set into mechanical oscillating motion. Advantageously, the passage of the pendulum lever through the rear wall of the bait body comprises a permanently elastic sealing means, for example made of rubber or silicone or another elastomer, and advantageously forms the pendulum bearing around which the pendulum lever of the permanent magnet pendulum actuator can be moved in a rotatably mounted manner. The pendulum bearing and the seal advantageously comprise an elastic material such as plastic, in particular elastomers, rubber or silicone, with a defined modulus of elasticity in the range from 0.5 MPa to 100 MPa, or a Shore A hardness according to DIN ISO 7619-1 in the range from 50 to 95 Shore 00 or from 10 Shore A to 90 Shore A, preferably in the range from 10 Shore A to 60 Shore A.

Advantageously, the permanent magnet can alternatively be arranged outside the bait body. In this case, the pendulum lever is movably mounted outside the bait body, and can be moved back and forth contactlessly by the changing magnetic field of the excitation coil. The pendulum lever passes into the tail fin, which it sets into mechanical oscillating motion. The permanent magnet can either be attached to a pendulum lever of the permanent magnet pendulum actuator located outside the bait body, or the permanent magnet can be integrated into the elastic body of the artificial fishing bait in the area of the tail fin or in the area of the tail fin of the dead fishing bait. In these embodiments, the pendulum bearing is located outside the bait body in the body shell of the artificial fishing bait or the dead natural fishing bait. The pendulum bearing advantageously comprises an elastic material such as, for example, plastic, in particular elastomers, rubber or silicone, with a defined modulus of elasticity in the range between 0.5 MPa to 100 MPa, or a Shore hardness A according to DIN ISO 7619-1 in the range from 50 to 95 Shore 00 or from 10 Shore A to 90 Shore A, preferably in the range from 10 Shore A to 60 Shore A.

In test series of both alternative embodiments, it was found that, compared to an alignment of the pole axis P2 parallel to the longitudinal axis Y of the bait body and a first pole axis P1 aligned transversely to the longitudinal axis Y or a further first pole axis P1′ expected to be advantageous, a reverse alignment, namely a first pole axis P1 aligned parallel to the longitudinal axis or a further first pole axis P1′ and the alignment of the pole axis P2 at a defined angle to the longitudinal axis L, preferably at right angles to each other, results in a surprising increase in the efficiency of the propulsion, whereby the parameters of the excitation current ie, the number of windings N and an advantageously dynamically effective air gap h, which decreases with increasing deflection sm of the pendulum lever, assumes a relative minimum in the end position and increases again with further deflection sm together with an optional elastic and/or resilient mounting of the permanent magnet pendulum actuator in synergy with a magnetic field of the permanent magnet transverse to the magnetic field of the excitation coil of the electromagnet, enable an increase in the moment of motion with a simultaneous reduction in the required excitation current ie. An optional elastic mounting comprises, for example, an elastomer, rubber or silicone or one or more permanently elastic springs made of metal or plastic.

The value of the dynamically effective air gap h between the electromagnet and the permanent magnet decreases as a function of a deflection sm of the pendulum lever when the pendulum drive moves towards its respective end position smE and assumes a relative minimum in the end position smE and the magnetic force effect Fm reaches a relative maximum. When passing the respective end position, the effective air gap h increases again, the magnetic force effect Fm on the permanent magnet pendulum actuator decreases and the direction of the force vector Fmd reverses, which causes the pendulum to be guided back to the end position smE, in which the magnetic force effect Fm has a relative maximum. The distance h and the magnetic force effect Fm are relative because the pendulum radius and the distance L of the pendulum pivot from the electromagnet, respectively from the core of the electromagnet, can be chosen differently in different embodiments.

The pendulum lever of the pendulum actuator is optionally transferred from a potential previous deflection to its zero position by an elastic bearing and/or by a spring when the electromagnet is not excited, i.e., when no excitation current ie flowing through the excitation coil of the electromagnet. The elastic bearing comprises, for example, an elastomer, rubber or silicone, or one or more permanently elastic springs made of metal or plastic.

In a neutral position, in particular in the zero position of the deflection of the pendulum lever, the magnetic center of the permanent magnet is initially at a distance h0 from the electromagnetic drive coil and is aligned with the pole axis of the electromagnet or is advantageously aligned with the center axis of a ferromagnetic core of the electromagnetic excitation coil. In this position, the permanent magnet exerts no force on a non-current-carrying air coil of the electromagnet or a minimal force on a core of ferromagnetic material of the electromagnetic excitation coil spaced at distance h0 from the magnetic center of the permanent magnet. The pendulum drive is in an unstable to slightly stable equilibrium position and can already be deflected in the positive direction sm+ or in the negative direction sm− with a weak electromagnetic pulse. Once deflected, the magnetic field of the permanent magnet begins to exert its force effect Fm on the magnetic field of the air coil and/or the magnetic field of the core of ferromagnetic material of the electromagnetic excitation coil and causes an increasing deflection of the pendulum drive, until the latter reaches a first positive end position smE+ or a second negative end position smE− at which the air gap hE reaches a minimum and thus the force effect Fm of the magnetic field of the permanent magnet on the magnetic field of the air coil and/or on the magnetic field of the ferromagnetic core of the electromagnetic excitation coil reaches a maximum. The end position of the pendulum, for example the first positive end position smE+, is reached either in a damped manner following an e-function, aperiodically transient or after a damped transient, depending on a damping effect of an elastic pendulum bearing and/or the flow forces acting on the tail fin when used in water.

The first end position can be reached without stopping and does not generate any mechanical noise, which would scare off a potential prey fish. The pendulum drive according to the invention operates extremely quietly. An elastic stop can optionally be provided to limit the pendulum swing.

In this case, advantageously, in addition to the restoring force of the tail fin in the water moving relative to the body shell, a speed-dependent damping resulting from the relative movement of the tail fin to the surrounding water and/or, by means of an optional elastic bearing, a restoring force Fr is generated, which damps the pendulum swing and/or restores the pendulum to its neutral position or to the zero position when excitation is outstanding, thus supporting the pole reversal process.

From this first end position, the pendulum drive is reversed by reversing the polarity of the voltage applied to the excitation coil of the electromagnet by causing an opposite current to flow through the excitation coil of the electromagnet. The oppositely polarized magnetic force field thus generated counteracts the magnetic force field of the permanent magnet and the restoring force caused by the elastic and/or resilient bearing of the pendulum drive supports an acceleration of the pendulum in the direction of the opposite second end position. In the process, the pendulum is deflected beyond the zero position by the force field of the electromagnet and the permanent magnet. In the process, the magnetic field of the permanent magnet again begins to exert its force effect on the magnetic field of the air coil and/or the magnetic field of the core made of ferromagnetic material and causes an increasing deflection of the pendulum drive until it reaches a negative end position smE−, at which the air gap hE reaches a minimum and thus the force effect Fm of the magnetic field of the permanent magnet on the magnetic field of the air coil and/or on the magnetic field of the core made of ferromagnetic material reaches a maximum. Depending on the damping effect of the elastic pendulum bearing and/or the flow forces acting on the tail fin when used in water, the second end position of the pendulum is reached either in a damped manner following an e-function, aperiodically transient or after a damped transient.

The second end position can be reached without a stop and therefore does not generate any mechanical noise there, which would deter a potential prey fish. The pendulum drive according to the invention operates extremely quietly. An elastic stop can optionally be provided to limit the pendulum swing.

The reversing process is advantageously supported by the intersecting pole axes of the electromagnet and the permanent magnet. Less reversing energy is required than with a parallel arrangement of the pole axes. As a result, the electromagnetic fishing bait drive gets by with a lower excitation current from the electromagnet, which means lower electrical power requirements from the electrical power source. As a result, the electromagnetic fishing bait drive achieves a longer running time of the electromagnetic fishing bait drive with smaller dimensions of the electrical power source.

The mass of the pendulum actuator together with the elastic pendulum bearing forms a mechanically oscillating spring/mass system with a mechanical resonant frequency dependent on its spring constant and mass. Advantageously, the electrical activation of the excitation coil has a periodic excitation voltage ue and a periodic excitation current ie with approximately the same frequency as the mechanical resonant frequency of the oscillating spring/mass system. As a result, the mechanical resonance of the pendulum actuator is also used to generate a moment of motion.

With the particularly advantageous bipolar control, an attraction of the permanent magnet towards the pole of the electromagnet takes place with opposite-pole excitation by the excitation current ie in the electromagnet with respect to the polarity of the permanent magnet, whereby the pendulum lever is moved away from its zero position. It is particularly advantageous if an excitation coil is arranged with the core made of ferromagnetic material, because the permanent magnet exerts a permanent magnetic attraction force on the core made of ferromagnetic material in the air gap and thus an additional magnetic force. Conversely, when the excitation current ie in the electromagnet is of the same pole, there is a repulsion of the permanent magnet away from the pole of the electromagnet with respect to the polarity of the permanent magnet, causing the pendulum lever to move back toward its zero position. If an excitation coil is arranged with the core of ferromagnetic material, the additional magnetic force exerted by the permanent magnet on the core of ferromagnetic material in the air gap must be overcome.

Advantageously, acceleration from one end position in the direction of the other end position is initiated by a current pulse which has a defined duty cycle compared with the drive frequency or the period of the pendulum drive. The current pulse ie entered for excitation of the excitation coil optionally and advantageously has a smaller integral over time than in the case of symmetrical or asymmetrical control. The integral of the current over time represents the charge to be taken from the electrical power source carried along for activation. A reduced pulse width can either increase the current pulse ie and thus the restoring torque for the same amount of charge, which increases the moment of motion of the propulsion, or it can reduce the charge to be taken from the electrical power source for the same moment of motion, which increases the running time of a particular electrical power source or allows a smaller electrical power source to be used for a comparable running time. The current pulse for the excitation current ie required for reversing the pendulum lever is only required to the extent that the pendulum lever needs it until it reaches a defined position between the end positions, preferably between one of the end positions and the zero position.

The impedance of the excitation coil depends on the air gap between the core of ferromagnetic material and the permanent magnet on the pendulum lever. Since the air gap changes dynamically with the position of the pendulum lever, the impedance of the excitation coil can advantageously be used to determine the position of the pendulum lever, for example by evaluating the course of the excitation current ie by a current sensor, for example a current measuring resistor, and forwarding it to the electronic control unit for further processing.

Alternatively or additionally, the magnetic field strength in the air gap can be detected by a magnetic field sensor, for example a magnetic field-dependent resistor or a Hall sensor, and forwarded to the electronic control unit for further processing. The measured magnetic field strength is a measure of the air gap and thus of the position of the pendulum lever. Further sensors are possible for detecting the position of the pendulum lever.

Advantageously, means are optionally arranged which detect the current position of the pendulum drive and transmit an electrical position signal to the electronic control unit. The electronic control unit determines from the current position of the pendulum drive whether or at what level an excitation current ie of the electromagnet is required for reversing, i.e. whether and in which direction the excitation current ie is required or whether the excitation current ie can be reduced or switched off without hindering the reversing process.

The reversal process of the pendulum lever from an end position smE+, smE− is carried out by the excitation current ie through the excitation coil of the electromagnet, whereby the excitation current ie is switched off or reduced when the pendulum lever has reached a defined position between the end positions smE+; smE−.

Advantageously, the defined position lies between one of the end positions smE+, smE− and the zero position of the pendulum lever.

Means for detecting the position of the pendulum lever are optionally arranged, the means causing the excitation current ie to be switched off or reduced via the electronic control unit. The means for detecting the position of the pendulum lever comprise magnetic position sensors or capacitive position sensors or electro-optical position sensors or inductive position sensors and/or the air gap-dependent excitation current ie is detected and evaluated for position detection.

Alternatively or additionally, the excitation coil of the electromagnet can be controlled via an electrical high-pass filter, for example by a capacitor in series with the impedance of the excitation coil, which dynamically generates high excitation current pulses in the excitation coil of the electromagnet and thereby limits the electrical charge taken from the electrical power source. In the reversing process of the activation, the excitation voltage ue applied to the excitation coil is doubled by the capacitor charged from the previous activation phase, initially and dynamically decreasing according to an e function, and due to the magnitude of the current pulse generated in this way, the magnetic induction of the electromagnet can be increased for reversing with reduced charge extraction from the electrical power source, as a result of which the air gap can be selected to be smaller and the moment of motion of the pendulum drive is thereby increased.

Alternatively, the excitation coil can be operated with a capacitor in parallel or in series as a resonant circuit to achieve a particularly low energy consumption of the propulsion, because in resonance only the energy loss has to be replenished to maintain the moment of motion. Advantageously, the mechanical resonant frequency, which depends on the oscillating mass of the pendulum actuator with its spring constant, has approximately the same frequency as the electrical resonant frequency of the resonant circuit. The mechanical frequency of the pendulum actuator and the electrical frequency of the resonant circuit of the activation are matched to each other in a range from 0 to 30%, advantageously from 0 to 10% and in particular from 0 to 5%.

In this case, the excitation coil of the electromagnet is driven by an electric oscillating circuit which is periodically triggered by a pulse of the excitation current ie, which limits the electric charge drawn from the electric power source.

Advantageously, a DC converter is arranged between the electrical power source and the electronic control unit and the propulsion, which adapts the voltage of the electrical power source to a higher voltage for supplying the electronic control unit and the propulsion.

Alternatively, less advantageously because with lower electromagnetic and also mechanical reversing energy than with bipolar control, the electromagnet can also be controlled by unipolar control instead of bipolar control, preferably comprising periodic electrical unipolar control. In unipolar drive, a core must be demagnetized at turn-off and before the next periodic magnetization, and appropriate means must be provided. These means consume magnetic energy and reduce the efficiency of the propulsion. Bipolar control of the electromagnet, on the other hand, is advantageously achieved via a bipolar power supply or, in the case of a unipolar power supply, via a full bridge with or without a coupling capacitor in series with the excitation coil or via a half bridge with a coupling capacitor in series with the excitation coil. Due to a required restoring torque of an elastic bearing and/or a spring, energy has to be applied for mechanical deformation and drive energy is lost. Bipolar control, on the other hand, advantageously controls the core magnetization without the disadvantages of unipolar control. The bipolar control is therefore more effective and can convert a higher drive power. In unipolar actuation, the zero position is in one of the end positions and is transferred to its zero position by an elastic bearing and/or by a spring from a potential previous deflection when the electromagnet is not excited, i.e., when no current flows through the excitation coil of the electromagnet. The elastic bearing comprises, for example, an elastomer, rubber or silicone, or one or more permanently elastic springs made of metal or plastic.

For secure attachment of the bait body to the connecting line to the angler, in both alternative embodiments, preferably at least one attachment means such as an eyelet or a clamp or a line swivel or a snap hook is arranged on the bait body. Alternatively, the attachment means may be attached to the body shell of the fishing bait independently of the bait body. Optionally, multiple attachment means may be provided at different positions to adjust the position of attachment of the connecting line to the angler to different control situations. Optionally, at least one attachment means may be adjustably and lockably disposed on the bait body. The connecting line to the angler is attached to one of the attachment means using known connection techniques, such as knots or line clamps. The connecting line to the angler may comprise a plurality of components such as a leader, a main line, and optionally a backing behind the main line. On the angler's side, the connecting line is preferably routed from the tip of a fishing rod through the fishing rod's eyelets to a reeling means operable by the angler.

At the attachment means for attaching the bait body or the body shell of the fishing bait to the connecting line to the angler, an inertial force component Fyr caused by the connecting line to the angler acts when the artificial fishing bait or the dead fishing bait is moved, for example when the artificial fishing bait or the dead fishing bait is retrieved and/or when the fishing rod is struck. The angler can cast the artificial fishing bait, in which the bait body is integrated, or the dead natural fishing bait, in which the bait body is integrated, as usual or let it into the water from the shore or from the boat and steer it towards a point in the water intended by him, where he suspects the predatory fish to be caught and can there attract the predatory fish to be caught by movements of the artificial fishing bait, in which the bait body is integrated, or the dead natural fishing bait, in which the bait body is integrated.

Optionally, additional controller means can be provided for controlling components arranged in the bait body.

For the controller of the components of the bait body, message detecting means can preferably be provided in the bait body, which convert defined changes in the inertial force component Fyr in the attachment point of the bait body of the connecting line from the bait body to the angler or in the speed v or an inertial negative acceleration of the bait body, in particular short jerky changes or longer dragged changes into electrical signals, which are decoded by the electronic control unit and converted into electrical control commands for controlling the control actuators and/or the excitation of the excitation coil of the electromagnet of the pendulum drive. Message detecting means may comprise, for example, an acceleration sensor, such as an integrated MEMS sensor or a line sensor. The acceleration sensor is particularly advantageous when the attachment means is not attached to the bait body, but may also be used when the attachment means is attached to the bait body. The line sensor is advantageously arranged when the attachment means is attached to the bait body. The line sensor comprises either a switch with a force-specific defined switching point or a sensor for analog conversion of force into an electrical value, such as a piezoelectric element, a strain gauge, an optoelectronic sensor, an inductive sensor or a capacitive sensor or a pressure sensor.

In this way, the angler can generate different mechanical signals or time-defined impulses using his conventional fishing assembly, for example by jerkily pulling back or by partially striking the tip of the fishing rod, which are mechanically transmitted to the bait body via the connecting line and are received as a signal by the message detecting means by means of time-defined and/or jerky changes. In this way, the angler can advantageously send out a controller message or several coded controller messages for controlling the bait body by single signals or by a temporal sequence of signals. Advantageously, the signals may also differ in length to thereby send individual characters and/or whole words comparable to Morse code to the bait body for controlling the control actuators and/or the electromagnetic pendulum drive. Advantageously, at least one start character and/or at least one stop character is optionally agreed upon, wherein an intervening sequence of characters with or without a start or stop character is interpreted as a message. Additionally or alternatively, a time window starting from the first character may be agreed upon, within which a sequence of characters is interpreted as a message.

The electronic control unit comprises an electronic circuit, advantageously a programmable microcontroller with program memory, data memory and corresponding drivers for controlling the control actuators and/or the electromechanical pendulum drive. The electronic control unit advantageously comprises a decoder for decoding the electrical signals converted by message detecting means. The semantic assignment or meaning of the encoding of messages may advantageously be fixed in the decoder or optionally programmed by the angler via an interface to the electronic control unit.

The interface may be a wired interface such as a USB interface or RS232 interface on the bait body with sealable contacts, or a wireless interface in the bait body such as a Bluetooth interface or WiFi interface. For programming the electronic control unit, on the angler's side, a computer such as a stationary or portable computer, a tablet or smartphone or other telecommunication means may be used. Advantageously, this computer has a further interface to a remote computer or an Internet in order to be able to download ready-made programs or updates for programming the electronic control unit of the bait body from there. Advantageously, particularly successful movement patterns for controlling the propulsion can be offered and downloaded from there.

The electromagnetic fishing bait drive can be controlled in response to a decoded message from the angler or on the basis of a program selection preset when the electromagnetic fishing bait drive is put into operation.

Advantageously, means may be provided which can control and/or temporarily turn off or on the electromagnetic pendulum drive of the invention with respect to frequency and/or amplitude. The frequency determines the number of deflections per unit time of the tail fin. This allows the speed of the movements to be determined on the one hand and the type of movement on the other. In the case of tail-side propulsion with magnetically moved oscillating tail fin, the amplitude of the tail fin deflections can be used to determine the strength of the movements. For example, a distinction can be made between the controller of a normal movement and a pattern of a sick movement.

For example, the electromagnetic fishing bait can be controlled so that the periodic electrical activation of the propulsion excitation occurs with an asymmetric curve in time, and the tail fin of the tail-side propulsion can be set into asymmetric oscillatory motion.

As a result, the amplitude deflections over time, i.e. the integral of the generated force and thus the performed work, are shifted in positive and in negative direction with respect to a neutral central position of the tail fin, respectively, the directional time-dependent position of the tail fin and thereby a directional control is achieved via an asymmetric oscillating movement of the tail fin. Depending on the vertical or horizontal orientation of the tail fin in neutral position, a controller of the movement of the artificial fishing bait, in which the bait body is integrated, or the dead natural fishing bait, in which the bait body is integrated, can be effected in this way.

The electrical power source for supplying the electronic control unit of the control actuators and the propulsion may be a battery or may be rechargeable electrical power sources such as an accumulator or a capacitor, for example a so-called “supercap”. In the case of a rechargeable electrical power source, charging may be accomplished via an external electrical power source such as a cigarette lighter from a car battery or from an external accumulator such as a “power pack” and via the wired interface.

Alternatively, a wireless charging process comparable to an electric toothbrush is possible, in which the electrical power is inductively or capacitively transmitted to a receiving unit in the bait body and from there transferred to its rechargeable electrical power source.

To optionally provide watertight access for replacing a battery or as access to a wired interface, there is advantageously provided on the bait body a screw cap with a seal or a resilient closure means, such as a sealing plug, which removably and reclosably release and reclose watertight access to the battery and/or the wired interface.

The control means further optionally comprise a sealed switching device operable from outside the bait body for producing and breaking an electrical joint between the electrical power source and the electrical loads such as the excitation coil of the electromagnetic pendulum drive, the electronic control unit, the drive driver for controlling the excitation coil of the electromagnetic pendulum drive, and the optional sensors and control actuators within the bait body. Alternatively, producing and breaking an electrical joint between the electrical power source and the electrical loads is accomplished by inserting or removing the electrical power source into the bait body or via a corresponding connecting contact (jumper) on the bait body.

Optionally, further manually operable control actuators can be provided, for example, means such as switches or potentiometers for setting the frequency and/or amplitude and/or duty cycle, respectively, a temporally symmetrical or asymmetrical curve progression of the electromagnetic pendulum drive and/or desired control program version and/or for shifting the center of buoyancy and/or center of gravity and/or flow bodies such as one or more elevators and/or rudders. Manually operable controller means are set by the angler according to a desired control option before launching the bait body or body shell. Thus, the angler produces an electrical joint from the electrical power source to the electrical components of the electromagnetic pendulum drive before launching the bait body or body shell into the water.

Advantageously, at least one means for tracking is optionally provided in the bait body. Means for localization are in particular GPS localization means or acoustic and or optical localization means, for example ultrasonic transmitters and/or LED. Locating means are preferably used to retrieve a bait body that may have been lost.

In the first alternative embodiment, the excitation coil of the electromagnet is advantageously formed longitudinally and predominantly rotationally symmetrically within the bait body along its longitudinal axis. The pole axis of the electromagnet P1 thereby runs essentially parallel to the longitudinal axis of the bait body. Advantageously, the excitation coil comprises a core of ferromagnetic material which either terminates inside the bait body at its rear outer wall or protrudes watertightly through the latter to the rear out of the bait body in order to exert from there the reciprocal force effect on the permanent magnet with dynamic air gap which then oscillates transversely back and forth. This means that narrow, elongated bait bodies with a high moment of motion can also be realized.

In the second alternative embodiment, at least one longitudinally oriented pole shoe or yoke of ferromagnetic material of an excitation coil oriented transversely to the longitudinal axis of the bait body Y is arranged and supports advantageously and in synergy with the requirements for realizing a high moment of motion with the lowest possible electrical energy consumption a streamlined design of the body shell of the fishing bait.

In both alternative embodiments, the at least one pole shoe or yoke of ferromagnetic material of the core of ferromagnetic material advantageously amplifies the field line concentration alternating in polarity. The pole shoe or the yoke of ferromagnetic material of the core of ferromagnetic material further supports the contactless end position of the pendulum actuator, since a balance of repulsive and ferromagnetic attractive force is established, which limits the angular deflection even without a stop and therefore noiselessly, which in synergy with the fin deflection damped by water leads to a propulsion-like fin acceleration. Optionally, an elastic stop can also be provided to limit the pendulum swing.

The at least one longitudinally oriented pole shoe or yoke made of ferromagnetic material or the longitudinally oriented rotationally symmetrical excitation coil advantageously supports, in synergy with the requirements for realizing a high moment of motion with the lowest possible electrical energy consumption, a streamlined design of the body shell of the fishing bait.

The electromagnetic pendulum drive can be realized in a compact and cost-effective manner and can be controlled and programmed in a simple way by changing the electrical excitation voltage and thus the electrical excitation current flowing through the excitation coil of the electromagnet in its curve shape, its frequency, its amplitude and its duty cycle respectively a temporally symmetrical or asymmetrical curve progression.

The electromagnetic fishing bait drive can thus be integrated in a space-saving manner even in small natural or artificial fishing baits, and it operates with high efficiency in that the force effect of the permanent magnet is exploited to advantage by utilizing a dynamic air gap in such a way that a high moment of motion is generated in the electromagnetic excitation coil with a low excitation current, whereby the size of the electrical power source can be reduced and the running time of a battery cell or a charge of an accumulator cell can be increased. At the same time, the electromagnetic fishing bait drive generates virtually no unnatural turning, striking or reversing noise. This makes the electromagnetic fishing bait drive a cost-effective and catchable addition to artificial fishing baits for a broad market of fishing accessories, and provides the ability to move dead natural fishing baits in a manner that is attractive to predatory fish.

In addition to oscillating lateral movement of the fishing bait, the propulsion generates a sum of force components Fyv at the drive point, directed forward in the y-direction at a drive point. The position of the drive point depends on the shape, area and material of the tail fin and on the fluidic design of the bait body. The drive point is preferably located in the rear half of the fishing bait in the transition area of the tail fin, in particular in the area of a pendulum bearing pivot axis.

Optionally, a float can be attached to the bait body to generate an upward buoyancy component Fa in addition to the buoyancy of the bait body. The float can be attached to the bait body in a defined manner at one or more front first attachment means. Alternatively, the position of the front first attachment means for attaching the float is adjustable and arranged to remain permanently in a position or to be fixed. Alternatively, the front first attachment means for attaching the float is connected to the bait body via a front first extension element. Advantageously, the front first extension element comprises elastically deformable material, for example metal or plastic, and remains in the set shape until the next deformation. By these measures, the fishing bait is statically trimmable in its inclination with respect to the plumb axis in synergy with the weight force of the propulsion and the components of the fishing bait, such as the power source, the control electronics, the attachment means, and dynamically trimmable in its inclination with respect to the plumb axis in synergy with the forward sum of force components Fyv generated by the propulsion in the y-direction, and the fishing bait is definably adjustable in its position in depth with respect to the surface of the surrounding water by the angler.

A natural lateral and/or forward course of motion due to the sum of force components Fyv generated by the propulsion forward in the y-direction depends on the mass of the propulsion of the fishing bait in relation to the mass of the remaining components of the fishing bait and the weight force thereby directed downward in the surrounding water, the upward directed buoyancy forces, the fluidic design of the bait body and the tail fin and the connection of the connecting line to the angler and the connection of an optionally used float to generate an additional upward directed buoyancy component.

The most natural lateral and/or forward movement of the baitfish generated by the propulsion and optionally its controllability with respect to the direction of motion v and the depth of the fishing bait in the surrounding water by an angler is determined by the position of the front first attachment means and the rear second attachment means as well as the front first deviation point and the rear second deviation point of the connecting line to the angler. The position of the attachment means and their deviation points, together with the propulsion, form a synergy that supports the task of creating a natural course of motion of the fishing bait.

The connecting line to the angler can be attached anywhere on the bait body depending on the desired lateral and/or forward movement v in the surrounding water. If a defined controllable forward movement v, directed away from the angler with natural course of motion of the bait body is to be achieved, the connecting line to the angler is to be fixed behind the drive point, preferably behind the pendulum bearing or an auxiliary straight line, the pendulum bearing axis of rotation, which runs axially inside the pendulum bearing.

In a preferred embodiment, therefore, the connecting line to the angler is attached behind the pendulum bearing pivot axis of the propulsion as viewed from the head end of the bait body.

When a float is used, the position of the front first attachment means for attaching the float to the bait body is advantageously chosen so that the longitudinal axis Y of the bait body is substantially horizontal or at a defined angle in the surrounding water as desired by the angler. The distance between the front first attachment means for attaching the float to the bait body and the float floating on the surface of the surrounding water determines the depth at which the fishing bait moves due to its propulsion.

The float is either attached to the bait body independently of the connecting line to the angler or, advantageously, the connecting line to the angler is movably looped through a rear second attachment means on the bait body forming a rear second deviation point to a front first attachment means on the bait body forming a front first deviation point, through which the connecting line to the angler is also movably looped on and guided to the float body to which the connecting line to the angler is attachable.

Advantageously, in one embodiment, a connecting tube is arranged inside the bait body through which the connecting line to the angler can be looped and whose rear second opening forms a rear second deviation point and whose front first opening forms a front first deviation point.

To limit the relative movement of the connecting line to the angler to the fastening means in the deviation points, a line stopper is adjustably fastened between the angler and the fishing bait at the connecting line to the angler and adherently fixable at the connecting line to the angler until the next adjustment.

The weight force causes the fishing bait to slide down along the connecting line to the angler first in the surrounding water until it reaches the position of the line stopper at the rear second deviation point of the rear second attachment means. A forward sum of force components Fyv generated by the propulsion in the y-direction initially causes the fishing bait to leave this position again, until the movement generated by the propulsion along the part of the connecting line to the angler located between the fishing bait and the float causes the float to move, thereby experiencing an upward force component in balance with a downward weight force which pulls the line stopper back to the rear second deviation point of the rear second attachment means to the bait body and stabilizes the position of the fishing bait on the connecting line to the angler and thus the depth at which the fishing bait moves.

By this kind of mounting a defined natural forward movement with a speed v in the direction of motion y according to the task is achieved advantageously in synergy together with the propulsion.

With an alternatively possible classical mounting of the float on the bait body, a defined natural movement is advantageously achieved in synergy together with the propulsion mainly by transverse movements of the fishing bait in the area of placement of the fishing bait in the surrounding water according to the task.

The propulsion is also suitable for applications of a pendulum drive where limited size and capacity of the electrical power source are limiting features. For example, the drive can be used for toys or technical pendulum applications with limited electrical drive energy, for example in automotive applications in the aerospace industry or for solar-powered pendulum drives or pendulum motors for permanent use even in low light conditions, for diving robots, for intrinsically low-noise drives or actuators, for example in watches, or in robotics as a pendulum actuator or pendulum motor for low-noise and efficient generation of dynamic forces, for example in household appliances such as shavers, toothbrushes, milk frothers, egg stirrers, fan fans, massage rods or in medical technology, for example in dental technology for cleaning, for gentle removal of tartar or for grinding or polishing teeth, in surgery for driving electric scalpels or for driving pumps for body fluids or for feeding food or for permanent low-noise massage or therapy of sensitive body parts, for compensation or for excitation of symmetrical or asymmetrical vibrations in mechanical or acoustic systems or the like.

For controlling an electromagnetic fishing bait drive, the following method steps may be used as examples:
Providing a bait body of an electromagnetic fishing bait drive according to the invention in a body shell of an artificial fishing bait or in the body shell of a dead natural fishing bait,
Attaching a connecting line to the angler to an attachment means of the bait body and/or the body shell,
Producing an electrical joint from the electromagnetic power source to the electrical components of the electromagnetic pendulum drive,
Releasing the body shell into the surrounding water.

Advantageously, the following additional method steps may optionally be used to control the electromagnetic fishing bait drive:
providing an electronic control unit comprising a decoder within the bait body or within the body shell,
providing a message detecting means, in particular a sensor, for detecting drag force variations between the bait body or the body shell and the connecting line to the angler and/or speed variations of the bait body or the body shell,
encoding a message by causing drag force variations on the connecting line to the angler by the angler and/or speed variations of the bait body or the body shell by causing drag force variations on the connecting line to the angler by the angler,
decoding the encoded message by the decoder in the bait body or body shell,
embodiment of a control action in response according to the decoded message by at least one control actuator and/or the electromagnetic pendulum drive.

The order of the method steps does not necessarily have to be followed as shown. Individual method steps can be brought forward or postponed without changing the effectiveness of the proposed method examples.

### BRIEF DESCRIPTION OF THE DRAWINGS

These and other features of the present invention will be apparent from the following description of preferred embodiments of the present invention, which are non-limiting examples, reference being made to the following figures.

FIG. 1 shows the situation of an angler with a fishing assembly and a fishing bait placed in a body of water,

FIG. 2 is the side view of a fishing bait with a tail-side propulsion with the electromagnetic fishing bait drive,

FIG. 3 shows the sectional plane A-B of the embodiment of a fishing bait of FIG. 2,

FIG. 4 shows an arrangement of control means and of drive means in the fishing bait in the representation of the sectional plane C-D of a side view,

FIG. 5 shows a principle arrangement of drive means in the fishing bait in the representation of the sectional plane A-B of a top view,

FIG. 6a shows a cross-section through the body shell and bait body of the fishing bait in the sectional plane E-F according to a first alternative embodiment,

FIG. 6b shows a longitudinal section through the body shell and bait body of the fishing bait according to a first alternative embodiment,

FIG. 6c shows as a detail of section G-H, a sectional view of the electromagnet and the components of the pendulum actuator according to a first alternative embodiment,

FIG. 6a′ shows a cross-section through the body shell and bait body of the fishing bait in the sectional plane E-F, of an embodiment according to a second alternative embodiment,

FIG. 6b′ shows a longitudinal section through the body shell and the bait body of the fishing bait of an embodiment according to a second alternative embodiment,

FIG. 6c′ shows as a detail of the section G-H, in part, the electromagnet and the components of the pendulum actuator of an embodiment according to a second alternative embodiment

FIG. 7a shows schematically the electromagnet and the components of the pendulum actuator in a zero position,

FIG. 7b shows schematically the electromagnet and the components of the pendulum actuator according to an embodiment of the first embodiment in a partially positively deflected state,

FIG. 7c shows schematically the electromagnet and the components of the pendulum actuator according to an embodiment of the first embodiment in its positive end position of deflection,

FIG. 7d shows schematically the electromagnet and the components of the pendulum actuator according to an embodiment of the first embodiment in its negative end position of deflection,

FIG. 8a shows the course of the dynamic air gap h as a function of the deflection sm,

FIG. 8b shows the course of the magnetic force Fm as a function of the deflection sm,

FIG. 9a shows the course of the magnetic moment of motion Mm as a function of the deflection sm of the pendulum lever,

FIG. 9b shows the course of the magnetic moment of motion Mm as a function of the deflection sm of the pendulum lever and the control ranges required for reversing,

FIG. 10 shows the principle relationship between the magnitude of the magnetic force and the magnitude of the air gap width,

FIG. 11 shows the arrangement of the electromagnetic pendulum drive within the bait body,

FIG. 12 shows schematic of the electromagnet and the components of the pendulum actuator of an embodiment of the first embodiment with a second pole axis P2, which is arranged in an angular range of 0°+/−40° to the longitudinal axis of the bait body,

FIG. 13 shows a sectional view of a fishing bait drive having an E-shaped pole shoe or yoke made of ferromagnetic material,

FIG. 14a and FIG. 14b show an embodiment with partially pot-shaped pole shoe or yoke made of ferromagnetic material,

FIG. 15 shows an assembly example with line stopper with external line guide, and

FIG. 16 shows an assembly example with line stopper with internal line guide.

### DETAILED DESCRIPTION

In the following, currently preferred embodiments of the present invention are explained in more detail with reference to the accompanying figures. Identical components have identical reference signs.

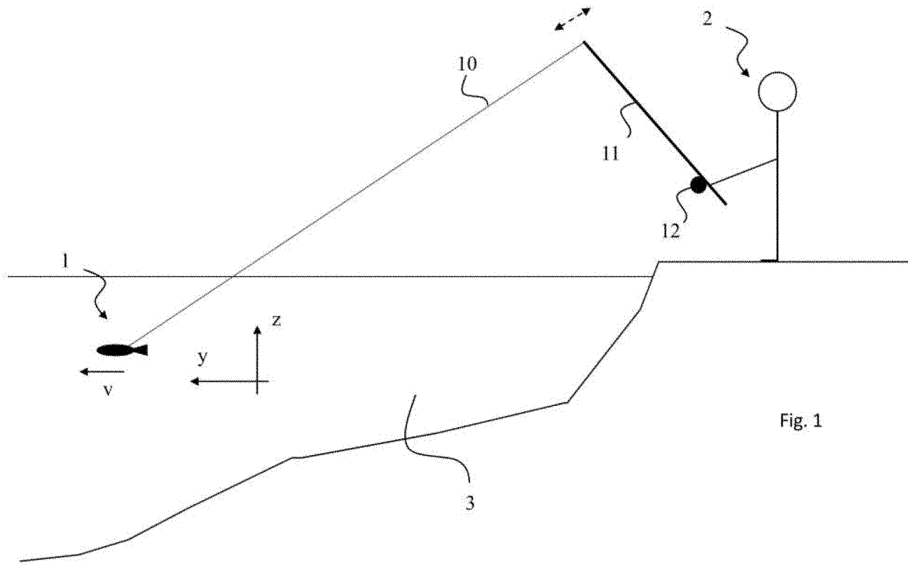

FIG. 1 shows the situation of an angler 2 with fishing assembly 10, 11, 12 and a fishing bait 1 introduced into a body of water 3. The fishing assembly comprises a reeling device 12, a fishing rod 11 and a connecting line 10 between the angler 2 and the fishing bait 1. In the example shown, the fishing bait 1 moves with a relative velocity v in the direction y in the surrounding water 3 and drags the connecting line 10 behind it. Alternatively, the fishing bait 1 may be cast and moved in a controlling manner with or without relative velocity v to imitate a moving prey fish. In practice, the experienced angler 2 will take care to ensure that the connecting line 10 is sufficiently taut to be able to selectively strike the fishing assembly in the event of a bite by a fish to be caught, that is, to ensure that a fishing hook of the fishing bait 1 is set in the fish to be caught by jerking the connecting line 10 towards itself.

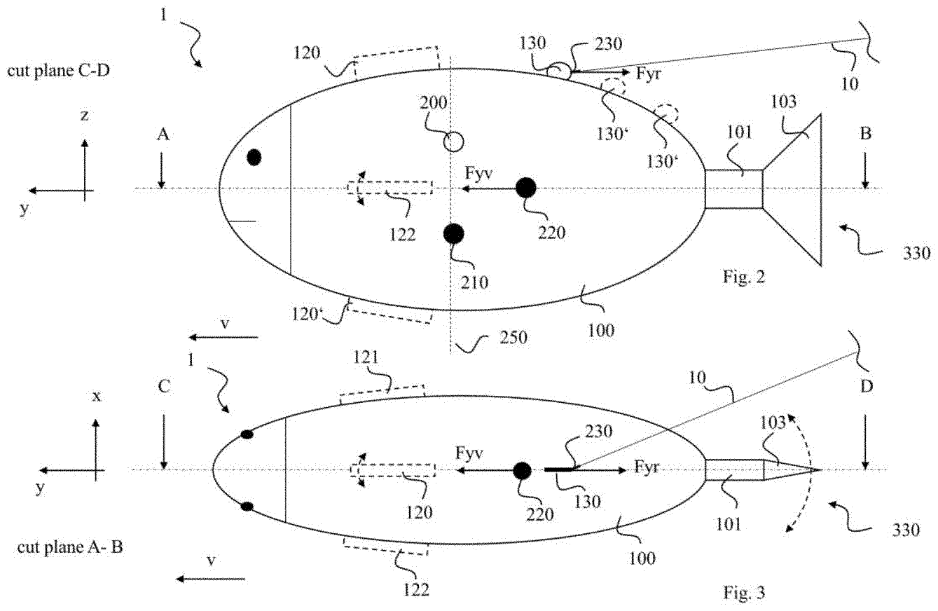

In FIG. 2, an embodiment of a fishing bait 1 having a tail-side propulsion 330 and a vertically oriented tail fin 103 for propulsion with the electromagnetic fishing bait drive is shown in the sectional plane C-D of the side view. Instead of a vertically oriented tail fin 103, a horizontally oriented tail fin 103 may be arranged for propulsion with the electromagnetic fishing bait drive. A connecting line 10 to an angler 2 (see FIG. 1) is attached to an attachment means 130 at an attachment point 230. At this point, an inertial force component Fyr engages, which in the case of forward movement of the fishing bait is caused by the backward force of the connecting line 10 to the angler 2, which is caused on the one hand by friction of the connecting line 10 to the angler 2 on the surrounding water 3 (see FIG. 1) and on the other hand by backward force action of the fishing rod assembly.

Optionally, several attachment means 130, 130′ may be provided at different positions in order to adapt the position of the attachment point 230 of the connecting line 10 to the angler 2 to different control situations. Optionally, at least one attachment means 130, 130′ may be adjustably and lockably arranged on the fishing bait 1.

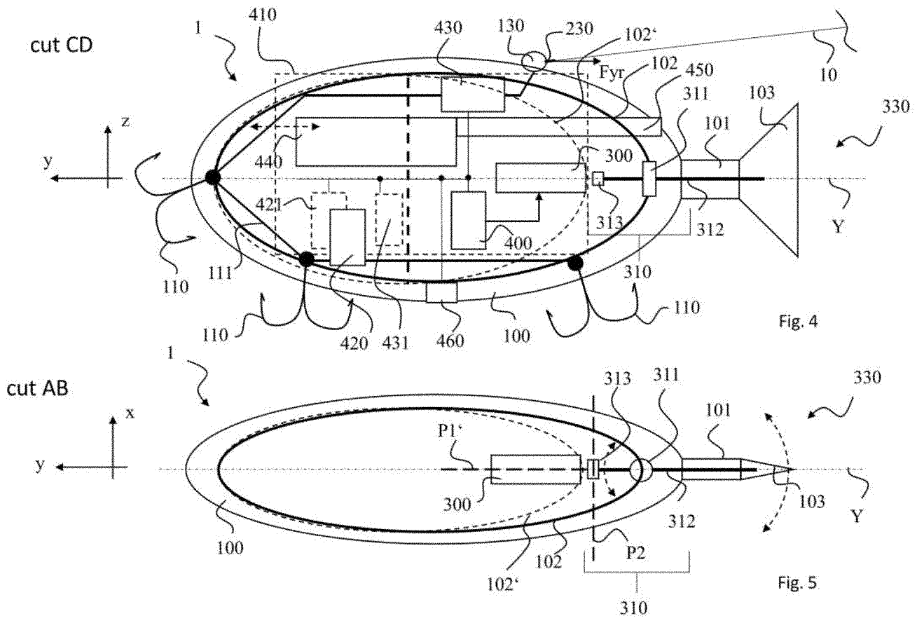

The fishing bait 1 has a center of buoyancy 200, in which the fishing bait 1 immersed in surrounding water 3 experiences a buoyant force directed upward toward the water surface by displacement of water volume. The position of the center of buoyancy 200 can be changed by an artificial swim bladder 440 (compare FIG. 4) arranged in the fishing bait 1 via its position and/or volume when the fishing bait 1 is substantially fixed in shape.

The fishing bait 1 further has a center of gravity 210, in which the fishing bait 1 introduced into surrounding water 3 experiences a weight force caused by the earth's gravity directed downward toward the bottom of the body of water. The position of the center of gravity 210 can be changed by changing the position of relatively heavy elements of the fishing bait 1, such as the electrical power source 420 (compare FIG. 4) or optional ballast weights (not shown).

The fishing bait 1 is designed with respect to the position of the center of buoyancy 200 and the center of gravity 210 in such a way that, when the fishing bait 1 is immersed in surrounding water 3, the center of buoyancy 200 is located above the center of gravity 210. This ensures a stable position of the fishing bait 1. Optionally, a floating pose can generate or supplement the buoyancy. Advantageously, in addition to the generated buoyancy, the position of the fishing bait 1 on the water surface is indicated. The connecting line which passes through the center of buoyancy 200 and through the center of gravity 210 is hereinafter referred to as the plumb axis 250. For static trimming of the fishing bait 1, the plumb axis 250 points in the direction of the center of gravity of the earth, that is, in the direction of the bottom of the body of water in which the self-movable artificial baitfish 1 is swimming.

For dynamic controller at existing relative velocity v between fishing bait 1 and surrounding water 3, flow bodies such as optionally shown elevators 122 and 121 (see FIG. 3) and/or optionally a rudder 120 at the top and/or optionally a rudder 120′ at the bottom may be arranged at the body shell 100 of the fishing bait 1 as controller means. The controller means 120, 120′, 121, 122, if present, are fixed or either manually adjustable for example via manually operable control actuators 450 (see FIG. 4) and/or via electrical control actuators (not shown) of the fishing bait 1.

In the embodiment shown, the tail fin 103 is oriented vertically. In this case, the oscillating motion transverse to the direction of motion y occurs in the positive and negative direction of the horizontal x-axis (see, for example, FIG. 3 or FIG. 5).

FIG. 3 shows the sectional plane A-B of the embodiment of a fishing bait 1 of FIG. 2 with tail-side propulsion 330 and vertically oriented tail fin 103 in plan view.

FIG. 4 shows an arrangement of control means and of drive means in the fishing bait 1 in the view of the sectional plane C-D of a side view.

In one embodiment, the bait body 102 is symbolized with a permanent magnet 313 disposed within the bait body with a continuous line. Alternatively, in one embodiment, the bait body 102′ is symbolized with a permanent magnet 313 disposed outside the bait body 102, 102′ with a broken line.

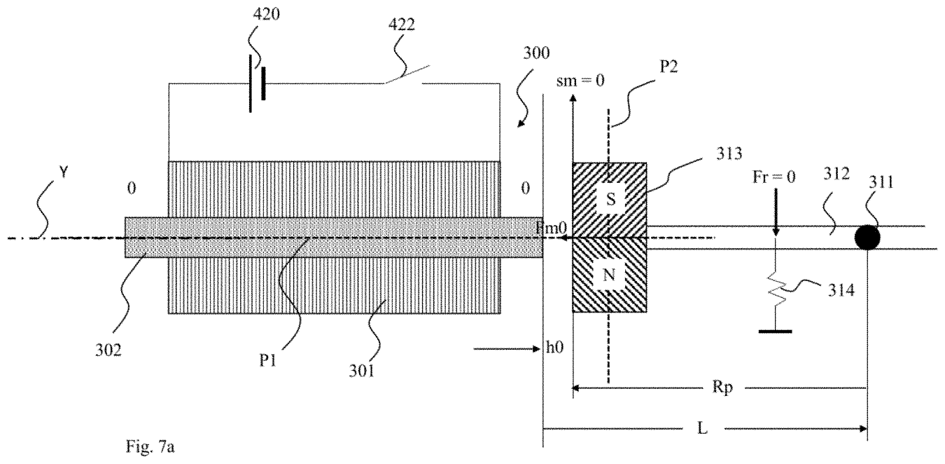

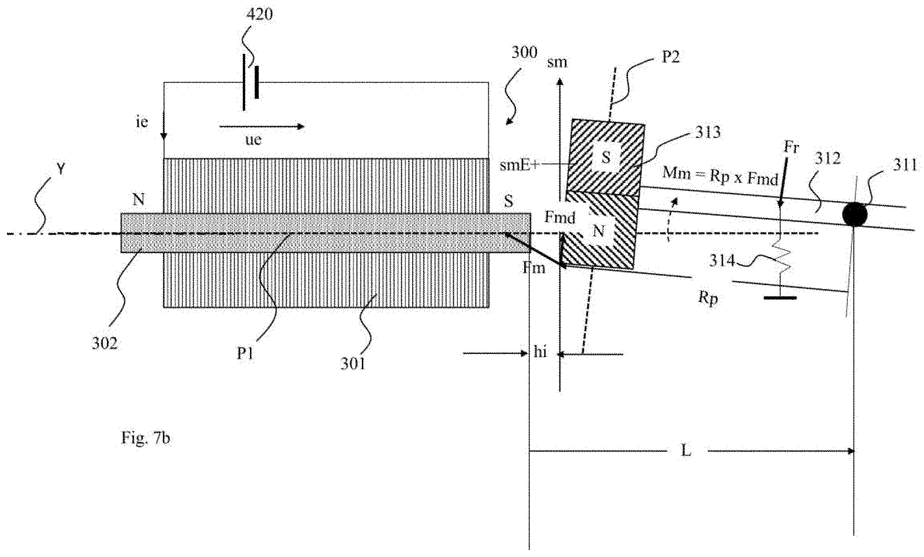

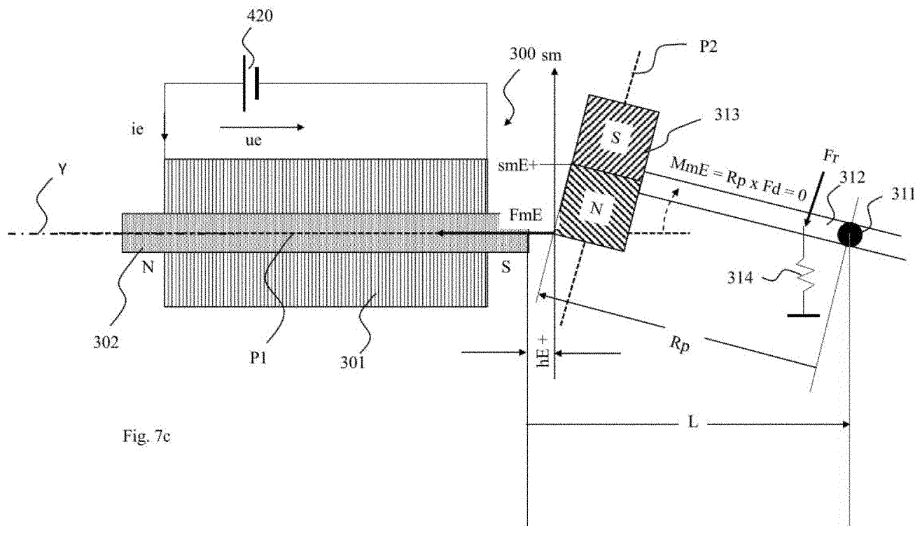

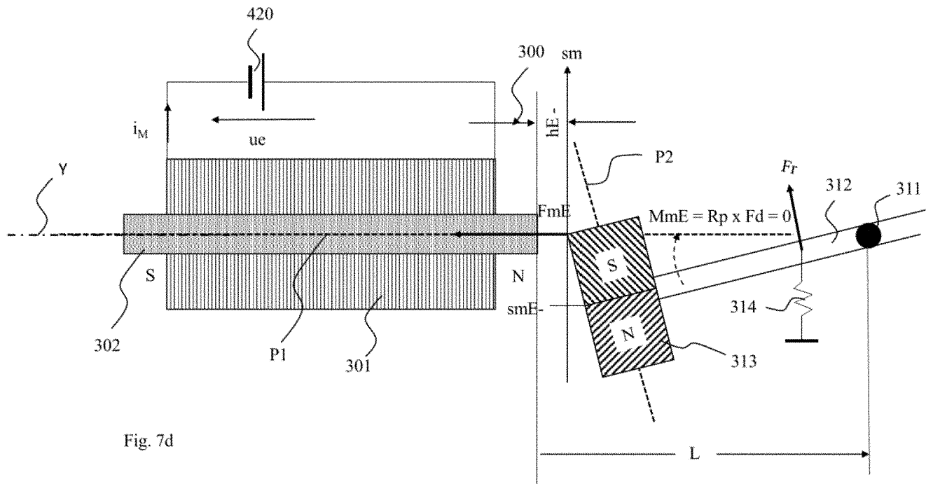

In addition to the bait body 102, 102′, the electromagnetic fishing bait drive comprises an electromagnetic pendulum drive. The electromagnetic pendulum drive comprises an electric power source 420, an electromagnet 300, an electronic control unit 410 and a pendulum actuator 310 comprising a permanent magnet 313 which is movably arranged transversely to the longitudinal axis of the bait body Y and a pendulum lever 312, on which the permanent magnet 313 is mounted in a pendulum radius Rp around a pendulum bearing 311 and an oscillating movement of the tail of the dead natural fishing bait 1 or the artificial fishing bait 1 with a defined deflection sm (see FIG. 7a to FIG. 9b) transverse to the longitudinal axis of the bait body Y.

The electromagnet 300, which exerts an electromagnetic force on the permanent magnet 313, generates an oscillating movement transverse to the longitudinal axis of the bait body Y, which is transmitted to a tail fin 103 via a pendulum lever 312 and a transition area 101 of the tail fin. Advantageously, a moment of motion may be generated via the pendulum bearing 311 and an overdrive or underdrive may be provided.

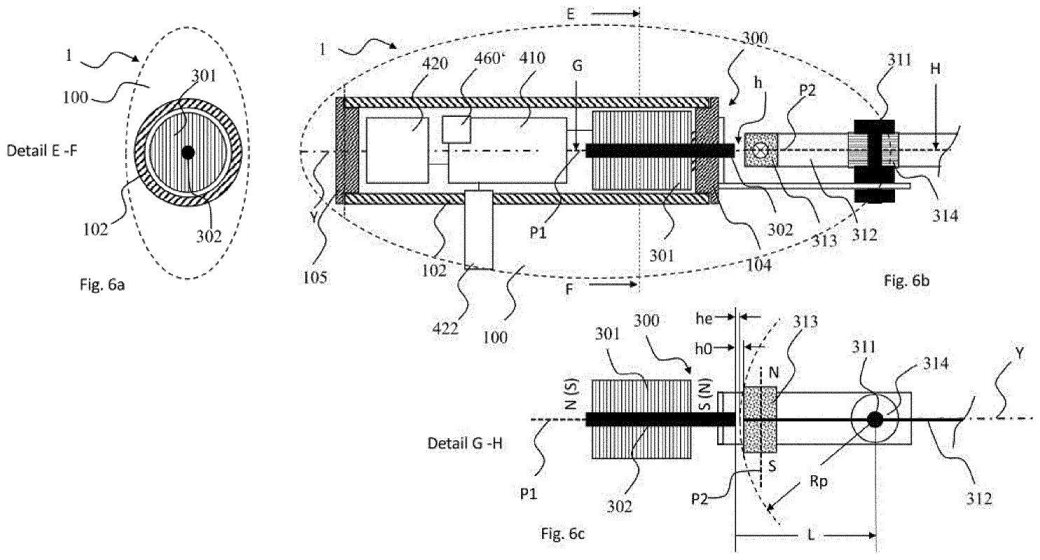

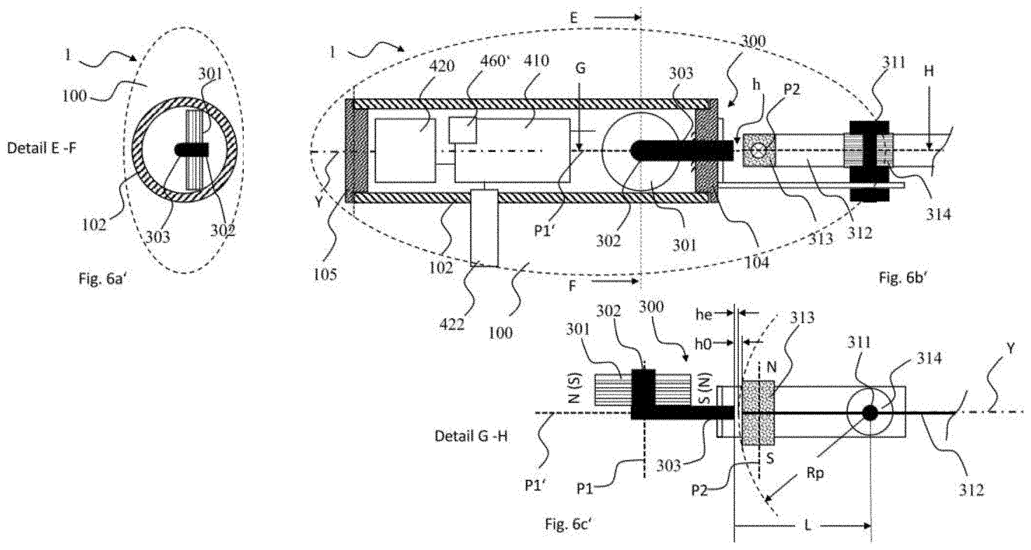

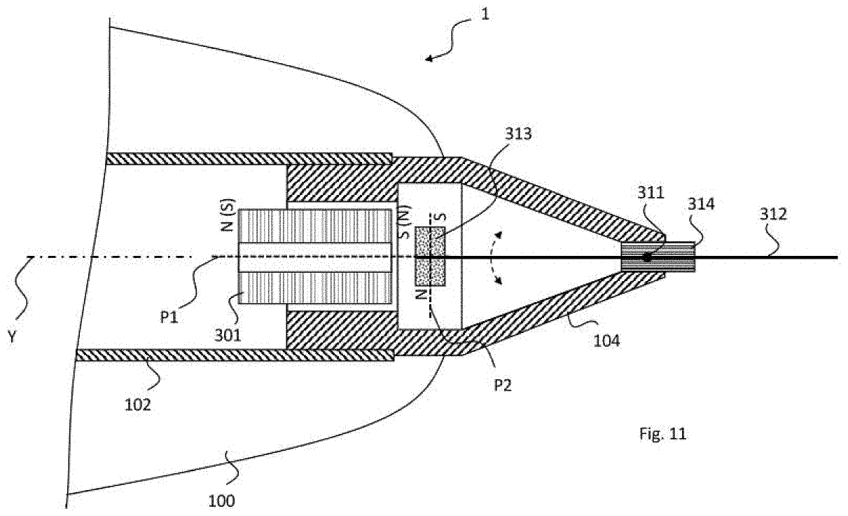

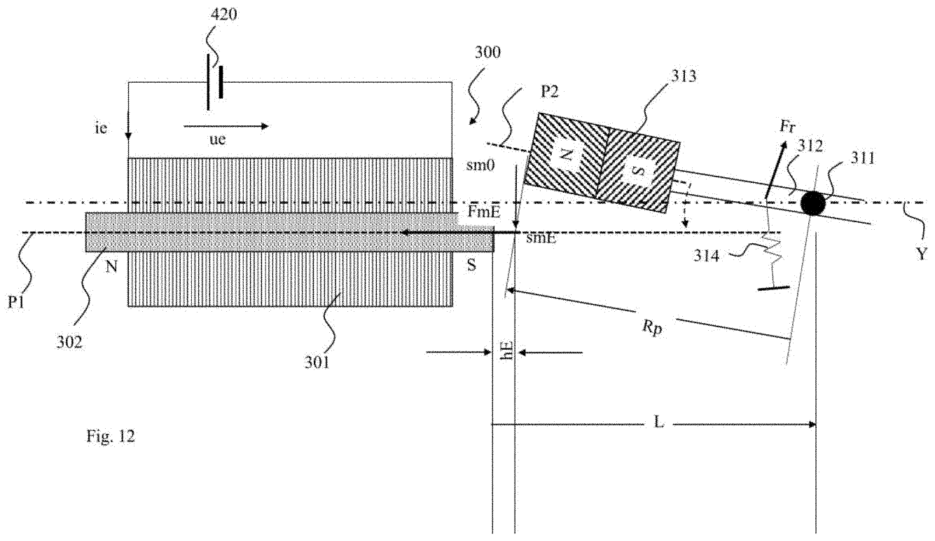

The electromagnet 300 comprises an excitation coil 301 (see FIGS. 6a and 6a′ to 7d, respectively, and FIGS. 11 and 12) of N windings with or without a core 302 of ferromagnetic material. Upon excitation by an excitation voltage ue (see FIG. 7a to FIG. 7d), an electric excitation current ie flows through the windings of the excitation coil 301 and generates an outgoing magnetic field with defined polarity N, S at the ends of the excitation coil 301 or at the ends of the core 302 of ferromagnetic material, depending on the direction of the current flow.

To control the electromagnetic pendulum drive via the electromagnet 300, a drive driver 400 is provided as part of the electronic control unit 410, which provides the conversion of control signals of an electronic control unit 410 into the signal required for the drive excitation 300 with a defined time-dependent curve progression of the electrical excitation voltage ue or the electrical excitation current ie. Advantageously, the electronic control unit 410 comprises discrete and/or partially integrated electronic components and/or a programmable microcontroller. The control signal of the electronic control unit 410 is provided either as a digital signal or as an analog signal to the drive driver 400. The drive driver 400 converts this signal into an electrical unipolar excitation voltage ue or into a bipolar excitation voltage ue or into a unipolar excitation current ie or into a bipolar electrical excitation current ie, respectively. For this purpose, an electrical power source 420 supplies either a unipolar supply voltage or a split, i.e. bipolar, supply voltage which is positively and negatively oriented with respect to an electrical potential point lying between the total voltage. In the case of bipolar control, the drive driver 400 comprises means such as a bridge circuit for alternation of polarity of the excitation voltage ue and the excitation current ie. Preferably, the drive driver 400 comprises an electronic H-bridge for generating a bipolar excitation voltage ue and a bipolar excitation current ie, respectively.

A line sensor 430 and/or an acceleration sensor 431 may optionally be provided as message detecting means in the electronic control unit 410. A message detecting means optionally detects the changes in the backward force component Fyr at the attachment point 230 or backward temporal velocity changes dv/dt as negative acceleration values of the fishing bait 1 provided for transmitting messages as a signal, converts them into an electrical signal and supplies it to the electronic control unit 410 for further evaluation of the temporal sequence of signals and, if necessary, for decoding.

Message detecting means may comprise, for example, an acceleration sensor 431, for example an integrated MEMS sensor and/or a line sensor 430.

In the case of an acceleration sensor 431, detecting is performed via a spring-mass acceleration sensor in the fishing bait 1. Such inertial sensors evaluate the inertial force acting on a mass and can be implemented very well on a silicon basis with so-called MEMS structures within an integrated electronic component in a compact and cost-effective manner. When a defined threshold value of the acceleration dv/dt detected in this way is exceeded, a signal is detected which is provided to the decoder for decoding.

The line sensor 430 comprises either a switch with a force-specific defined switching point, which changes its electrical switching contact in a defined manner at a defined mechanical inertial force component at the attachment point Fyr and thereby generates an electrical signal at a defined inertial force component at the attachment point Fyr, or a sensor for analog conversion of the inertial force component at the attachment point Fyr into an electrical value, such as the result signal of a piezo element, a strain gauge, an optoelectronic sensor, an inductive sensor, a capacitive sensor or a pressure sensor.

Electrical power is supplied to the electrical components of the electromagnetic pendulum drive via a unipolar electrical power source 420 or via a split, bipolar electrical power source 420. Battery cells or rechargeable electrical power sources such as accumulators or capacitors, for example so-called “supercaps”, may be provided as the electrical power source 420 for supplying the electronic control unit 410 of the control actuators, the drive driver 400 and the electromagnet 300. In the case of a rechargeable electrical power source 420, charging may be provided from an external electrical power source such as a car battery cigarette lighter or from an external rechargeable battery/“power pack” and via the wired interface 460.

Advantageously, a DC converter 421 is arranged between the electrical power source 420 and the electronic control unit 410 and the electromagnet 300, which adapts the voltage of the electrical power source 420 to a higher voltage for supplying the electrical components of the electromagnetic pendulum drive. Preferably, the voltage converter is embodied as an inductive step-up converter, for example in the form of a so-called boost converter or step-up converter. In this case, a low input voltage range of 0.8 V to 3.8 V is stepped up to a higher output voltage of 2.0 V to 18 V.

The advantage of this arrangement is that single or multiple simple, for example alkaline/manganese cells or, for example, lithium cells, which are available in various formats, for example in AAA or AA format or as button cells in various sizes, can be used inexpensively and widely with high charge capacity to operate the propulsion and the electronic control unit. The cell voltage of a single alkaline cell is 1.5 V. The practical usable voltage range of alkaline/manganese cells or of lithium iron sulfide cells, is between 1.2 V and 1.7 V. The practically usable voltage range of other lithium cells is from 2.0 V to 3.8 V.

Furthermore, the advantage of this arrangement is that as energy supply single or several simple rechargeable accumulator cells, for example in NiCd or NiMh or lithium-ion or NiZk technology hereinafter referred to as accumulator cells, which are available in different formats, for example in AAA or AA format or as button cells in different sizes at low cost and widely available with high charge capacity, can be used to operate the propulsion and the electronic control unit. The cell voltage of a single NiCd or NiMh cell is 1.2 V, and that of a NiZk cell is 1.6 V. The practically usable voltage range of these cells is between 0.8 V and 1.7 V. The cell voltage of a single lithium-ion cell is 3.7 V. The practically usable voltage range of this cell is between 3.0 V and 3.8 V.

This results in the following particularly advantageous input voltage ranges for the DC converter based on the input voltage range of 0.8 V to 3.8 V:
0.8V to 1.7V
2.0V to 2.8V
3.0V to 3.8V

Series connections of individual cells are also possible. This can result in integer multiples of the mentioned cell voltages as input voltage ranges.

In order to have a sufficiently high voltage swing available for the control of the electromagnetic propulsion even when using an H-bridge, bipolar integrated circuits with a lower operating voltage of 4.5 V (selected from 3.5 V) or integrated CMOS circuits with a lower operating voltage of 2.5 V (selected from 2.0 V) can be considered.

The upper limit of the supply voltage of these circuits is usually 18 V. This results in the output voltage range of the DC converter being 2.0 V to 18 V. Preferably, the output voltage range is between 4.0 V and 6 V and particularly preferably between 4.5 V and 5.5 V.

To shift the center of gravity 210 (cf. FIG. 2), the mass of the electrical power source 420 and/or the mass of a ballast body (not shown) can optionally be changed in its position within the body shell 100 of the fishing bait 1 via electrical control actuators (not shown) and/or manually via a sealed manual control means that can be operated from the outside and extends into the body shell 100, such as a manually operable control actuator 450. For example, a manually operable control actuator 450 comprises mechanical adjustment means such as a screw, clamp, slide, valve or the like, or electrical adjustment means such as a potentiometer, switch, electrical or magnetic activatable contact/measurement point or the like.

The interface 460 may be a wired interface, such as a USB interface or an RS232 interface or other proprietary interface on the fishing bait 1 with sealable contacts, or a wireless interface in the fishing bait 1, such as a Bluetooth interface or a WiFi interface. A computer such as a stationary computer, a portable computer, a tablet or a smartphone may be used by an angler 2 to program the electronic control unit 410. Advantageously, this computer has a further interface to a remote computer or the Internet, in order to be able to download from there ready-made programs or updates for programming the electronic control unit 410 of the fishing bait 1.

The self-movable fishing bait 1 comprises at least one fishing hook 110 for hooking a predatory fish to be caught on the fishing bait 1 in the event of a successful bite. Advantageously, the fishing hook 110 is resiliently connected to the fastening device 130 via a fishing hook reinforcement 111 in order to ensure a secure mechanical joint between the predatory fish to be caught and the angler 2 via the connecting line 10 to the angler 2 even in the event of a violent drill, and to enable the catch to be retrieved by the angler 2.

An optionally arranged artificial swim bladder 440 serves for defined positioning of the center of buoyancy 200 (cf. FIG. 2) within the body shell 100 of the fishing bait 1. For displacement of the center of buoyancy 200, the volume of the artificial swim bladder 440 and/or the position of the center of buoyancy 200 within the body shell 100 can optionally be changed via electrical control actuators (not shown) or manually via a manually operable control actuator 450. Shifting the center of buoyancy 200 relative to the center of gravity 210 changes the position of the plumb axis 250 relative to the direction of motion y, and thus changes the static position (trim) or angle of the plumb axis 250 of the fishing bait 1 relative to, for example, the vertical z-direction in the surrounding water 3. Optionally, a floating pose may alternatively or additionally generate or supplement buoyancy. In the case of a dynamic movement v of the fishing bait 1 relative to the surrounding water 3, it can be determined together with one or more flow bodies, for example one or more elevators 121, 122 (see FIG. 3 and FIG. 4), in which vertical z-direction the self-movable artificial baitfish 1 swims.

Optionally, a pressure sensor (not shown) for detecting the static water pressure of the current diving depth may be arranged at the electronic control unit 410, wherein in joint with the electronic control unit 410 the means for controlling the diving depth are controllable to maintain a certain predetermined diving depth based on programming or in response to a decoded message from the angler.

Optionally, means (not shown) for delivering acoustic attractants and/or visual attractants and/or taste attractants for attracting prey fish may be provided on the electronic control unit 410, and may optionally be activated and deactivated by the control unit 410. Means for delivering acoustic attractants may comprise an electromechanical vibrator that delivers vibrations, in particular simulating a sick baitfish to the surrounding water. Means for delivering visual attractants may comprise, for example, a flashing light-emitting diode or a light-emitting diode emitting a continuous signal, which emits attractant visual signals to the surrounding water. Means for delivering flavored attractants may comprise a manually fillable attractant tank that can be emptied by control signal, or a permanently drainable attractant tank in the self-movable artificial baitfish that delivers a flavored attractant substance, such as simulating a body fluid of a sick or dead bait, or an aromatic substance, to the surrounding water.

Advantageously, at least one means for locating (not shown) is optionally provided in the self-movable fishing bait 1. In particular, GPS locating means and/or acoustic locating means, for example ultrasonic transmitters, and/or optical locating means, for example a flashing light-emitting diode, are provided as means for locating. Means for locating are preferably used for the retrieval of a fishing bait 1 that may have been lost.

FIG. 5 illustrates a principal arrangement of drive means in the fishing bait in the representation of the sectional plane A-B of a plan view. Here, the electromagnet 300 within the bait body 102, 102′ causes an oscillating movement of the permanent magnet transversely to the longitudinal axis of the bait body Y due to an electromagnetic force effect. The motion is transmitted to the Transition area of the tail fin 101 and to the tail fin 103 via the pendulum lever 312 and the drive bearing point 311. As a result, the pendulum lever 312, the transition area of the tail fin 101 and the tail fin 103 are directly set into oscillating motion transverse to the longitudinal axis of the bait body Y. Therefore, a natural movement of the fishing bait 1 is produced without any unnatural mechanical vibration due to contact, rotary motion, commutation, bearing of a drive motor or from a gearbox, or from an eccentric mechanism or the like. The propulsion is largely noiseless and emits the same vibrations when the tail fin 103 moves in the surrounding water 3 as a living fish does in its natural movement situations from standing in the water 3 to escaping or moving when injured or sick.

FIG. 6a shows a cross-section through the body shell and bait body of the fishing bait in the cut plane E-F according to a first alternative embodiment. The cut plane E-F shows a section through a cylindrically shaped excitation coil 301 and a ferromagnetic core 302, which are centrally located within a circular tube of the bait body 102.

FIG. 6b shows a longitudinal section through the body shell and bait body of the fishing bait according to a first alternative embodiment. The body shell 100 of the fishing bait 1 receives the bait body 102 therein along the longitudinal axis of the bait body Y. The tubular bait body 102 is sealed watertight at its head end by the front outer wall of the bait body 105, and at its tail end by the rear outer wall of the bait body 104. Advantageously, the bait body 102 may be removed from the body shell 100 or opened within the body shell 100, for example, by a means of severing the body shell 100 at its forward end. By removing the front outer wall of the bait body 105, the bait body 102 may be opened to replace the electrical power source 420 or to gain access to an interface 460′ of the electronic control unit 410 disposed within the bait body 102 through which the electronic control unit 410 is controllable and/or programmable. For example, one means of controller comprises a manually operable control element 422 that is either accessible to the user when the bait body 102 is open or operable from outside the bait body 102 when sealed in a watertight manner. The manually operable control element 422 comprises, for example, an on/off switch that can be used to produce or cut off power from the electromagnetic power source 420 to the electrical components of the electromagnetic pendulum drive. The manually operable control element 422 may further allow, for example, a step switch or an adjustment knob or other controls for manually changing the control parameters, such as frequency, pause times, etc., of the controller of the electromechanical pendulum drive. The bait body 102 houses the electronic control unit 410 with its electrical components, the electrical power source 420, and the excitation coil 301 with its core of ferromagnetic material 302. In this embodiment, the rear end of the core of ferromagnetic material 302 passes through the rear outer wall of the bait body 104 in a watertight manner to form the rear end of the electromagnet 300. Alternatively, the rear end of the core of ferromagnetic material 302 may be disposed within the bait body 102.

In this embodiment, the permanent magnet 313 is located outside the bait body 102 at a distance h from the electromagnet 300 comprising a core of ferromagnetic material 302 of the excitation coil 301. In this case, the pendulum lever 312 is movably supported outside the bait body 102, and is reciprocally movable contactless by the magnetic field of the excitation coil 301. The pendulum lever transitions to the tail fin (not shown), which it sets into mechanical oscillating motion. In this example, the permanent magnet 313 is composed of two stacked cube-shaped permanent magnets forming a common pole axis P2 transverse to the longitudinal axis of the bait body Y. The permanent magnet 313 is attached to the pendulum lever 312 of the permanent magnet pendulum actuator located outside the bait body 102. Alternatively, the permanent magnet 313 may be integrable into the body shell 100 of the artificial fishing bait 1 in the tail fin region or into the tail fin region of the dead fishing bait 1.

In these embodiments, the pendulum bearing 311 is located outside the bait body 102 in the body shell 100 of the artificial fishing bait 1 or the dead natural fishing bait 1. The pendulum bearing 314 of the artificial fishing bait 1 advantageously comprises an elastic material such as, for example, plastic, in particular elastomers, rubber or silicone, having a defined modulus of elasticity in the range between 0.5 MPa to 100 MPa, or a Shore hardness A according to DIN ISO 7619-1 in the range from 50 to 95 Shore 00 or from 10 Shore A to 90 Shore A, preferably in the range from 10 Shore A to 60 Shore A.

FIG. 6c shows, as a detail of section G-H, a section of the electromagnet and the components of the pendulum actuator according to a first alternative embodiment. Shown in plan view is the electromagnet 300, comprising the excitation coil 301 and the core of ferromagnetic material 302.

The first pole axis P1 of the electromagnet is parallel to the longitudinal axis of the bait body Y. The pendulum bearing 311 is disposed at a distance L from the electromagnet 300. The pendulum actuator, comprising the permanent magnet 313 and the pendulum lever 312, is shown in its zero position, in which no excitation current ie flowing through the excitation coil 301. The pendulum lever 312 is moved to the zero position by the elastic return element 314. The pole axis P2 is oriented transversely at right angles to the longitudinal axis of the bait body Y. In the zero position, the permanent magnet 313 has the air gap h0 to the core of ferromagnetic material 302 of the permanent magnet 300. The edges of a cuboid formed by two cube-shaped permanent magnets extend along the interrupted line at a distance Rp from the pendulum bearing when the pendulum lever 312 rotates about the pendulum bearing 311. Thereby, the edges have a minimum air gap he.

FIG. 6a′ shows a cross-section through the body shell and bait body of the fishing bait in the section plane E-F of an embodiment according to a second alternative embodiment, The section plane E-F shows a section through a cylindrically shaped excitation coil 301 and a ferromagnetic core 302 and a pole shoe or yoke of ferromagnetic material 303, which are arranged within a round tube of the bait body 102.

FIG. 6b′ shows a longitudinal section through the body shell and bait body of the fishing bait of an embodiment according to a second alternative embodiment. The body shell 100 of the fishing bait 1 receives the bait body 102 therein along the longitudinal axis of the bait body Y. The tubular bait body 102 is sealed watertight at its head end by the front outer wall of the bait body 105, and at its tail end by the rear outer wall of the bait body 104. Advantageously, the bait body 102 may be removed from the body shell 100 or opened within the body shell 100, for example, by a means of severing the body shell 100 at its forward end. By removing the front outer wall of the bait body 105, the bait body 102 may be opened to replace the electrical power source 420 or to gain access to an interface 460′ of the electronic control unit 410 disposed within the bait body 102 through which the electronic control unit 410 is controllable and/or programmable or the electrical power source 410 is chargeable. One means of controller comprises, for example, a manually operable control element 422 that is either accessible to the user when the bait body 102 is open or operable from outside the bait body 102 when sealed in a watertight manner. The manually operable control element 422 comprises, for example, an on/off switch that can be used to produce or cut off power from the electromagnetic power source 420 to the electrical components of the electromagnetic pendulum drive. The manually operable control element 422 may further allow, for example, a step switch or an adjustment knob or other controls for manually changing the control parameters, such as frequency, pause times, etc., of the controller of the electromechanical pendulum drive. The bait body 102 houses the electronic control unit 410 with its electrical components, the electrical power source 420, and the excitation coil 301 with its core of ferromagnetic material 302 and the pole shoe or yoke of ferromagnetic material 303. In this embodiment, the rear end of the core of ferromagnetic material 302 passes through the rear outer wall of the bait body 104 in a watertight manner and forms the rear end of the electromagnet 300. Alternatively, the rear end of the core of ferromagnetic material 302 may be formed in a watertight manner within the bait body 104 and forms the rear end of the electromagnet 300.

In this embodiment, the permanent magnet 313 is located outside the bait body 102 at a distance h from the electromagnet 300 comprising a core of ferromagnetic material 302 of the excitation coil 301. In this case, the pendulum lever 312 is movably supported outside the bait body 102, and is reciprocally movable contactless by the magnetic field of the excitation coil 301. The pendulum lever transitions to the tail fin (not shown), which it sets into mechanical oscillating motion. In this example, the permanent magnet 313 is composed of two stacked cube-shaped permanent magnets forming a common pole axis P2 transverse to the longitudinal axis of the bait body Y. The permanent magnet 313 is attached to the pendulum lever 312 of the permanent magnet pendulum actuator located outside the bait body 102. Alternatively, the permanent magnet 313 may be integrable into the body shell 100 of the artificial fishing bait 1 in the tail fin region or into the tail fin region of the dead fishing bait 1.

In these embodiments, the pendulum bearing 311 is located outside the bait body 102 in the body shell 100 of the artificial fishing bait 1 or the dead natural fishing bait 1. The pendulum bearing 314 of the artificial fishing bait 1 advantageously comprises an elastic material such as, for example, plastic, in particular elastomers, rubber or silicone, having a defined modulus of elasticity in the range between 0.5 MPa to 100 MPa, or a Shore hardness A according to DIN ISO 7619-1 in the range from 50 to 95 Shore 00 or from 10 Shore A to 90 Shore A, preferably in the range from 10 Shore A to 60 Shore A.

FIG. 6c′ shows, as a detail of section G-H, a section of the electromagnet and the components of the pendulum actuator of an embodiment according to a second alternative embodiment. Shown in plan view is the electromagnet 300, comprising the excitation coil 301 and the core of ferromagnetic material 302.

The first pole axis P1 is guided tail-side to the rear via at least one pole shoe or yoke of ferromagnetic material 303 and forms a further first pole axis P1′ of the pole shoe or yoke of ferromagnetic material 303, which preferably has an angle in the range of 0°+/−30°, preferably 0°+/−10°, in particular in the range of 0°+/5° to the longitudinal axis of the bait body Y and therefore runs substantially parallel to the longitudinal axis of the bait body Y.

The further first pole axis P1′ is parallel to the longitudinal axis of the bait body Y. The pendulum bearing 311 is arranged at a distance L from the electromagnet 300. The pendulum actuator, comprising the permanent magnet 313 and the pendulum lever 312, is shown in a zero position in which no excitation current ie flowing through the excitation coil 301. The pendulum lever 312 is moved to the zero position by the elastic return element 314. The pole axis P2 is oriented transversely at right angles to the longitudinal axis of the bait body Y. In the zero position, the permanent magnet 313 has the air gap h0 to the core of ferromagnetic material 302 of the permanent magnet 300. The edges of a cuboid formed by two cube-shaped permanent magnets extend along the interrupted line at a distance Rp from the pendulum bearing when the pendulum lever 312 rotates about the pendulum bearing 311. Thereby, the edges have a minimal air gap he.

FIG. 7a schematically shows the electromagnet and the components of the pendulum actuator according to an embodiment of the first embodiment in a zero position. Shown in plan view is the electromagnet 300, comprising the excitation coil 301 and the core of ferromagnetic material 302.

The pole axis P1 is parallel to the longitudinal axis of the bait body Y. The pendulum bearing 311 is located at a distance L from the electromagnet 300. The pendulum actuator, comprising the permanent magnet 313 and the pendulum lever 312, is shown in a zero position in which no excitation current ie flowing through the excitation coil 301. The joint of the power source 420 to the excitation coil 301 is broken by a manually operable control element 422. In this embodiment, the pendulum lever 312 is moved to the zero position by an optional elastic return element 314. The restoring force Fr in this position is 0. The pole axis P2 is oriented transversely at right angles to the longitudinal axis of the bait body Y. In the zero position, the permanent magnet 313 has the air gap h0 to the core of ferromagnetic material 302 of the permanent magnet 300. The return element 314 may optionally be omitted because the restoring force is provided by the reversing in the case of reversing excitation of the electromagnet 300 continuously or for a sufficiently long time within a deflection period, and/or by a force action of the surrounding water 3 flowing past the fin.

In the zero position, the magnetic center of the permanent magnet 313 is at a distance h0 from the ferromagnetic core 302 of the excitation coil 301 and is aligned with the pole axis P1. In this position, the permanent magnet 313 exerts a minimum force Fm0 on a core of ferromagnetic material 302 of the electromagnetic excitation coil 301 spaced at distance h0 from the magnetic center, which is the magnetically neutral zone of the permanent magnet to the side of the permanent magnet. The pendulum drive is in an unstable to slightly stable equilibrium position and can already be deflected in the positive direction sm+ with a weak positive electromagnetic pulse or in the negative direction sm− with a weak negative electromagnetic pulse. The deflection sm of the pendulum lever 312 is 0 in this position.

FIG. 7b schematically shows the electromagnet and the components of the pendulum actuator according to an embodiment of the first embodiment in a partially positively deflected state.

The circuit between the power source 420 and the excitation coil 301 is closed. The electromagnet 300 is driven with alternating polarity (cf. FIG. 7b versus FIG. 7c), comprising an electrically bipolar AC voltage as drive voltage ue at the excitation coil 301 and a bipolar flowing AC current as excitation current ie through the excitation coil 301 of the electromagnet 300.

The excitation voltage ue is applied to the excitation coil 301 in the positive direction and a positive excitation current ie flows through the excitation coil 301. As a result, a south pole S is formed along the first pole axis P1 at the rear end of the core of ferromagnetic material 302 and a north pole N is formed at the front end of the core of ferromagnetic material 302. The polarities are chosen by way of example and may also have reversed polarity. In the illustrated position of the pendulum lever 312, the latter has left the zero position in the positive sm direction and has reached a deflection sm, but not yet its positive end position smE+.

The effective air gap hi between the electromagnet 300 and the permanent magnet 313 decreases dynamically after leaving the zero position as a function of the deflection sm of the pendulum lever 312 when the pendulum drive moves towards its respective end position smE. The magnetic force fm of the permanent magnet 313 is concentrated on the edge of the permanent magnet 313 that forms the smallest air gap hi. As the air gap hi decreases, the magnetic force component increases and takes a relative minimum at the end position smE and the magnetic force effect Fm reaches a relative maximum. Until the end position is reached, the magnetic force component forms a force component Fmd acting perpendicularly on the pendulum lever. This produces the magnetic moment of motion Mm acting on the pendulum lever at distance Rp.

When the respective end position smE is exceeded, the effective air gap h increases again, the magnetic force effect Fm on the permanent magnet pendulum actuator decreases and the direction of the force vector Fmd reverses, whereby the pendulum is guided back to the end position smE, in which the magnetic force effect Fm has a relative maximum. The distance h and the magnetic force effect Fm are relative because the pendulum radius and the distance of the pendulum pivot from the electromagnet, respectively from the core of the electromagnet, can be chosen differently in different embodiments.

As the deflection sm increases, the restoring force Fr of the elastic return element 314 also increases and generates a small counter-torque compared to the magnetic moment of motion Mm.

FIG. 7c schematically shows the electromagnet and the components of the pendulum actuator according to an embodiment of the first embodiment in its positive end position of deflection.

Once deflected, the magnetic field of the permanent magnet 313 begins to develop its force effect Fm on the magnetic field of the core of ferromagnetic material 302 of the electromagnetic excitation coil 301 and causes an increasing deflection of the pendulum drive, until the latter reaches a positive end position smE+ or a negative end position smE− at which the air gap hE reaches a minimum and thus the force effect Fm of the magnetic field of the permanent magnet 313 on the magnetic field of the core of ferromagnetic material 302 of the electromagnetic excitation coil 301 reaches a maximum. The end position of the pendulum, for example the positive end position smE+ is thereby reached, depending on the damping effect of an optional elastic return element 314 of the pendulum bearing 311 and/or the flow forces acting on the tail fin when used in water 3 (cf. FIG. 1), either in a damped manner following an e-function, aperiodically transiently or after a damped transient process.

In this case, in addition to the restoring force of the tail fin in still or moving water 3, a speed-dependent damping resulting from the relative movement of the tail fin to the surrounding water and/or a restoring force Fr is generated by the elastic return element, which damps the pendulum swing and/or returns the pendulum to its zero position when excitation is outstanding and thus supports the pole reversal process.

FIG. 7d schematically shows the electromagnet and the components of the pendulum actuator according to an embodiment of the first embodiment in its negative end position of deflection.

From the position shown in FIG. 7c, the pendulum drive is reversed by flowing an opposite current ie through the excitation coil 301 of the electromagnet 300 by reversing the polarity of the voltage ue applied to the excitation coil 301 of the electromagnet 300. The oppositely polarized magnetic force field of the electromagnet 300 thus generated opposes the magnetic force field of the permanent magnet 313 and supports the restoring force Fr caused by the elastic return element 314 to accelerate the pendulum lever 312 in the direction of the opposite end position. In the process, the pendulum lever 312 is deflected in the opposite direction beyond the zero position by the force field of the electromagnet 300 and the permanent magnet. In the process, the magnetic field Fm of the permanent magnet 313 again begins to exert its force effect on the magnetic field of the core of ferromagnetic material 302 and causes an increasing deflection of the pendulum lever 312 until the latter reaches a negative end position smE−, at which the air gap hE reaches a minimum and thus the force effect Fm of the magnetic field of the permanent magnet on the magnetic field of the core of ferromagnetic material 302 reaches a maximum. The end position of the pendulum lever 312 is thereby reached, depending on the damping effect of the elastic return element 314 and/or on the flow forces acting on the tail fin during use in the water 3, either in a damped manner following an e-function, aperiodically transient or after a damped transient.

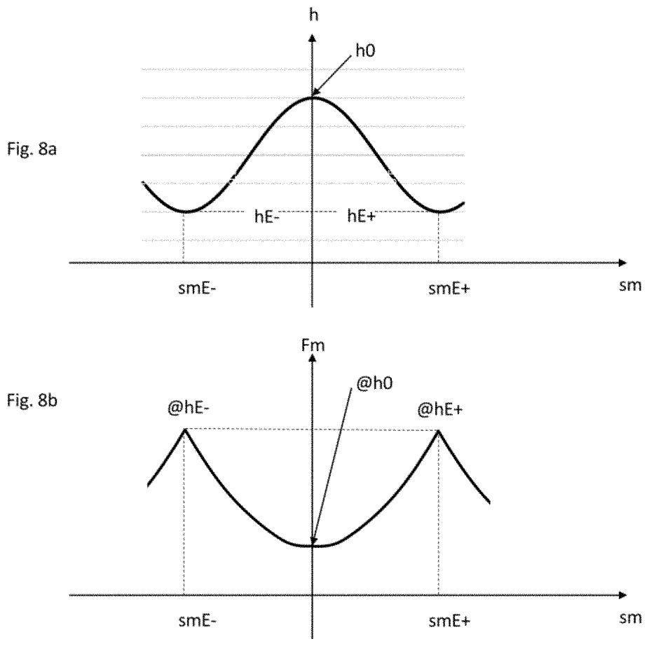

FIG. 8a shows the course of the dynamic air gap h as a function of the deflection sm. In the above embodiments, the air gap h has a minimum in the end positions of the pendulum lever 312 smE and a maximum in the zero position of the pendulum lever 312 smO.

The air gap h is the shortest distance between the permanent magnet 313 of the permanent magnet pendulum actuator and the pole of the electromagnet 300 of the electromagnetic pendulum drive. A dynamic air gap h is the air gap h formed when the permanent magnet pendulum actuator moves as a function of the deflection of the permanent magnet pendulum actuator from its rest position. The air gap h advantageously varies in the range between 20 mm and 0.05 mm, in particular between 5 mm and 0.05 mm and preferably between 2 mm and 0, 5 mm.

FIG. 8b shows the course of the magnetic force effect Fm as a function of the deflection sm. The magnetic force effect Fm has a minimum at the largest air gap h0 in the zero position of the pendulum lever 312 and assumes a maximum at the smallest air gap in the respective end positions of the pendulum lever 312 smE. The smaller the air gap h can be selected in synergy with the pendulum radius, the elastic and dynamic restoring torque, the number of windings N and the magnitude of the excitation current ie, the greater the moment of motion of the permanent magnet pendulum actuator that can be achieved and thus the moment of motion of the fishing bait drive.

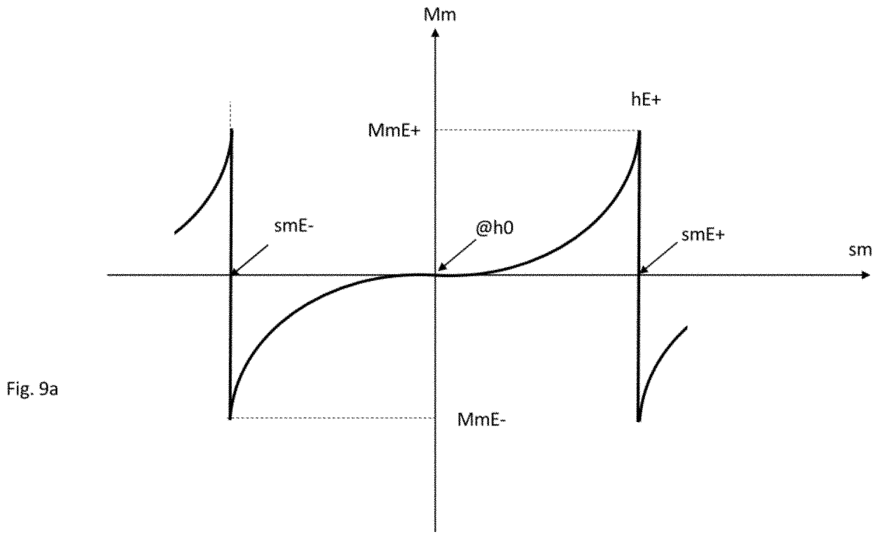

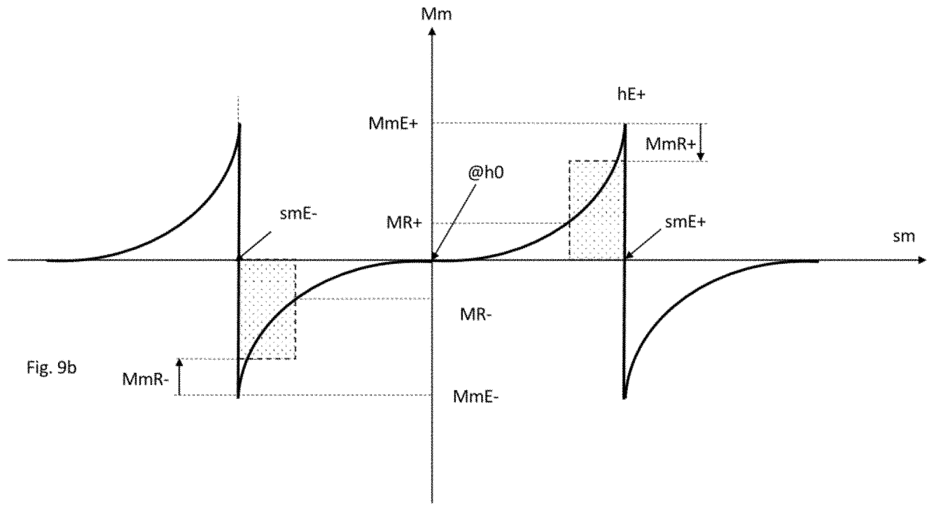

FIG. 9a shows the variation of the magnetic moment of motion Mm as a function of the deflection sm of the pendulum lever. As the deflection sm of the pendulum lever increases in the positive or negative direction, the air gap decreases (see FIG. 8a). As the air gap hi decreases, the magnetic force component Fm˜1/h increases hyperbolically and reaches a relative maximum at the end position smE. Until the end position is reached, the magnetic force component forms a force component Fmd acting perpendicularly on the pendulum lever. This produces the magnetic moment of motion Mm acting on the pendulum lever at the distance Rp. The magnetic moment of motion reaches a relative maximum MmE in the respective end position. When the respective end position smE is exceeded, the effective air gap h increases again, the magnetic force effect Fm on the pendulum lever 312 decreases and the direction of the force vector Fmd reverses, whereby the pendulum is guided back to the end position smE, in which the magnetic force effect Fm has a relative maximum. The relationship of Mm as a function of the deflection sm has a pole point in each of the end positions smE of the pendulum lever 312, which stabilizes the pendulum lever 312 in the end positions smE until reversing by the electromagnet in the end points smE. This results in a maximum force effect Fm and a stop-free and therefore noise-free limitation of the deflection sm of the pendulum lever 312 can take place, because the attraction between the permanent magnet 313 and the pole shoe or the yoke made of ferromagnetic material or the core made of ferromagnetic material 302 reaches a stabilizing critical maximum MmE in the end positions. An elastic stop can optionally be provided to limit the pendulum swing.

FIG. 9b shows the variation of the magnetic moment of motion Mm as a function of the deflection sm of the pendulum lever and the control ranges required for reversing. The pendulum lever 312 of the pendulum drive is reversed (cf. FIG. 7d) by reversing the polarity of the voltage ue applied to the excitation coil 301 of the electromagnet 300 by causing an opposite current ie to flow through the excitation coil 301 of the electromagnet 300. The oppositely polarized magnetic force field of the electromagnet 300 thus generated counteracts the magnetic force field of the permanent magnet 313 and supports the restoring force Fr caused by the elastic return element 314 to accelerate the pendulum lever 312 in the direction of the opposite end position.

The restoring magnetic moment of motion Mm to be applied for this purpose must overcome the force effect caused by the permanent magnet 313 when attracted to the core of ferromagnetic material 302 and/or to the pole shoe or the yoke of ferromagnetic material 303 and the resulting moment of motion Mm in order to initiate the reversing of the pendulum lever 312. In this regard, the required restoring moment MmR is assisted by a permanent elastic restoring moment caused by the elastic restoring means and by a restoring moment applied to the tail fin by the surrounding water 3. The magnetic restoring moment of motion MmR can be reduced by the amount of these additional restoring moments. Further, reversing advantageously requires reversing excitation of the electromagnet 300 only until the pendulum lever reaches the range in which the permanent elastic restoring moment alone is sufficient to overcome the residual attractive moment of the permanent magnet 313. The accelerated mass of the permanent magnet 313 advantageously exerts sufficient kinetic energy on the pendulum lever 312 to move it further beyond the zero position towards the opposite end position, where it is picked up and stabilized by the counter-pole excited electromagnet which starts again.

In the process, the pendulum lever 312 is deflected in the opposite direction beyond the zero position by the force field of the electromagnet 300 and the permanent magnet.

For reversing, the acceleration from one end position in the direction of the other end position is advantageously initiated by a current pulse which has a defined duty cycle compared with the drive frequency or the period of the pendulum drive. The current pulse ie thereby entered for excitation of the excitation coil 301 advantageously has a smaller integral over time than in each case with symmetrical or asymmetrical control. The integral of the current ie over time represents the charge to be drawn from the entrained electrical power source 420 for actuation. By reducing the pulse width of the excitation current ie, either the amplitude of the current pulse ie and thus the restoring torque can be increased for the same amount of charge, which increases the moment of motion of the propulsion, or the charge to be taken from the electrical power source 420 can be reduced for a constant moment of motion, which increases the running time of a particular electrical power source 420 or allows a smaller electrical power source 420 to be used for a comparable running time.

Advantageously, a sensor is optionally arranged to detect the current position of the pendulum lever 312 and to transmit this information to the electronic control unit 410 (cf. FIG. 4). The electronic control unit 410 determines from the current position of the pendulum lever 312 whether excitation of the electromagnet 300 is required for reversing, whether the excitation current ie required, or whether the excitation current ie can be reduced or switched off without hindering or supporting the reversing process.

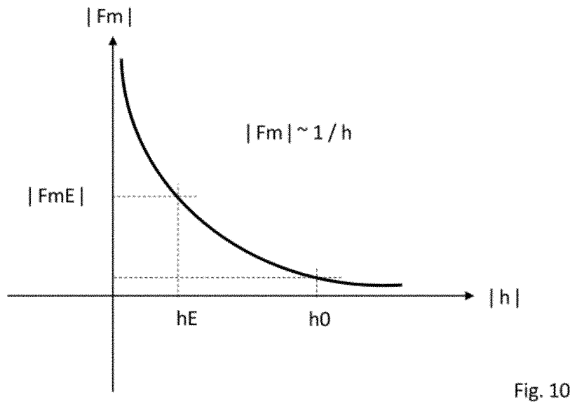

FIG. 10 shows the principle relationship between the magnitude of the magnetic force and the magnitude of the air gap width. The illustration shows the basically hyperbolic relationship between the magnitude of the magnetic force effect and the magnitude of the air gap width, which is derived from the relationship of the magnetic force in the air gap according to the equation

Fm˜K*(ie*N/h)²,

can be represented. With decreasing air gap h, the magnetic force Fm increases quadratically-hyperbolically.

Due to the advantageous arrangement of the electromagnet 300 (cf. FIG. 4 to FIG. 7d and FIG. 11), on the one hand, the high magnetic holding force of the permanent magnet 313 is used to generate a high magnetic moment of motion Mm in synergy with the effect of the electromagnetic force field of the electromagnet 300, which attracts during deflection sm and compensates during reversing, in order to effect compensation of the magnetic field required for reversing with the lowest possible excitation current ie and thus in an energy-saving manner with respect to the energy source 420 carried along, and thus to initiate an energy-saving reversing of the pendulum actuator.

FIG. 11 shows an arrangement of the electromagnetic pendulum drive within the bait body. The permanent magnet 313 is disposed within the bait body 102. The bait body 102 is enclosed tail-side by the body cavity 100 of the artificial or dead natural fishing bait 1. In this regard, the pendulum lever 312 is mounted within the bait body 102 in the rear outer wall 104 thereof and is reciprocated in a contactless manner by the magnetic field of the excitation coil 301. A pendulum actuator formed thereby is movably carried out of the rear end of the bait body 102, sealed against ingress of water, and passes into the tail fin, which it sets into mechanically oscillating motion transversely to the longitudinal axis Y of the bait body. Advantageously, the passage of the pendulum lever 312 through the rear wall of the bait body 104 comprises the permanently elastic return element 314, further advantageously comprising a permanently elastic sealing means, for example made of rubber or silicone or another elastomer, and advantageously forms the pendulum bearing 311 around which the pendulum lever 312 of the pendulum actuator is rotatably movable. The pendulum bearing 311 and the seal provided by the permanently elastic return element 314 advantageously comprise an elastic material such as, for example, plastic, in particular elastomers, rubber or silicone, with a defined modulus of elasticity in the range between 0.5 MPa to 100 MPa, or a Shore hardness A according to DIN ISO 7619-1 in the range from 50 to 95 Shore 00 or from 10 Shore A to 90 Shore A, preferably in the range from 10 Shore A to 60 Shore A. The body shell 100 may, in the case of a dead natural fishing bait 1, completely coat the pendulum actuator so that the pendulum actuator causes lateral movement of the body of the fishing bait and/or its tail fin 103.

FIG. 12 schematically shows the electromagnet and the components of the pendulum actuator of an embodiment of the first embodiment with a second pole axis P2, which is arranged in an angular range of 0°+/−40° to the longitudinal axis of the bait body.

Thereby, the excitation coil 301 is arranged with the first pole axis P1 in an angular range of 0°+/−40° to the longitudinal axis of the bait body Y and there is arranged the permanent magnet 313 with the second pole axis P2 in an angular range of 0°+/−40° to the longitudinal axis of the bait body Y. Advantageously, a bipolar control is used. Alternatively, in this embodiment, a unipolar actuation can optionally be provided in a less advantageous manner. In this embodiment, the zero position is located in one of the end positions smE and is transferred by the elastic return element 314 from a possibly previous deflection to a zero position when the electromagnet 300 is not excited, that is, when no current ie flowing through the excitation coil 301 of the electromagnet 300. The elastic return element 314 comprises, for example, an elastomer, rubber or silicone, or one or more permanently elastic springs made of metal or of plastic. In the case of bipolar control, when the excitation current ie in the electromagnet 300 is in opposite polarity with respect to the polarity of the permanent magnet 313, the permanent magnet 313 is attracted towards the pole of the electromagnet 300, causing the pendulum lever 312 to move away from its zero position. It is particularly advantageous if an excitation coil with ferromagnetic core 302 is arranged, because the permanent magnet 313 exerts an additional magnetic force Fm on the core of ferromagnetic material 302 in the air gap h due to a permanent magnetic attraction force. Conversely, when the excitation current ie in the electromagnet 300 is of the same pole, a repulsion of the permanent magnet 313 away from the pole of the electromagnet 300 occurs with respect to the polarity of the permanent magnet 313, causing the pendulum lever 312 to move back to its zero position. When an excitation coil 301 with core of ferromagnetic material 302 is arranged, the additional magnetic force exerted by the permanent magnet 313 on the core of ferromagnetic material in the air gap h must be overcome in the process. In order to achieve a symmetrical movement of the tail fin 103 with respect to the longitudinal axis of the bait body Y, a laterally offset arrangement of the pendulum actuator and/or the electromagnet 300 with respect to the longitudinal axis of the pendulum actuator Y is advantageous in this embodiment.

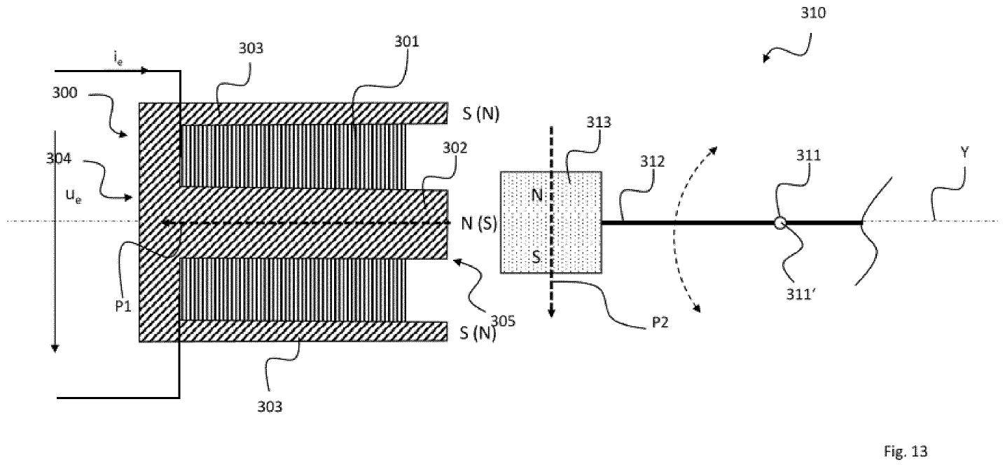

FIG. 13 shows a sectional view of a fishing bait drive with an electromagnet 300 comprising an excitation coil 301 with a first pole axis P1 and a pendulum actuator comprising a permanent magnet 313 with a second pole axis P2 and a pendulum lever 312, wherein due to an electromagnetic force field of the electromagnet 300 the permanent magnet 313 is movable transversely to the longitudinal axis of the bait body Y, wherein the excitation coil 301 is arranged with the first pole axis P1 at an angle in the range of 0°+/−30° to the longitudinal axis of the bait body Y, with an E-shaped pole shoe or yoke 303 of ferromagnetic material, wherein a central core 302 of ferromagnetic material is disposed within the excitation coil 301 and is passed over ferromagnetic material outside of the excitation coil 301 from a first pole end 304 of the central core of ferromagnetic material 302 to a second pole end 305 of the central core of ferromagnetic material 302, forming a pole shoe or yoke of ferromagnetic material 303 which at the second pole end 305 of the central core of ferromagnetic material 302 has an air gap to the central core of ferromagnetic material 302 in which the permanent magnet 313 is movably arranged in such a way that the projection of the first pole axis P1 by the excitation coil 301 and the second pole axis P2 by the permanent magnet 313 intersect in at least one position at a defined angle.

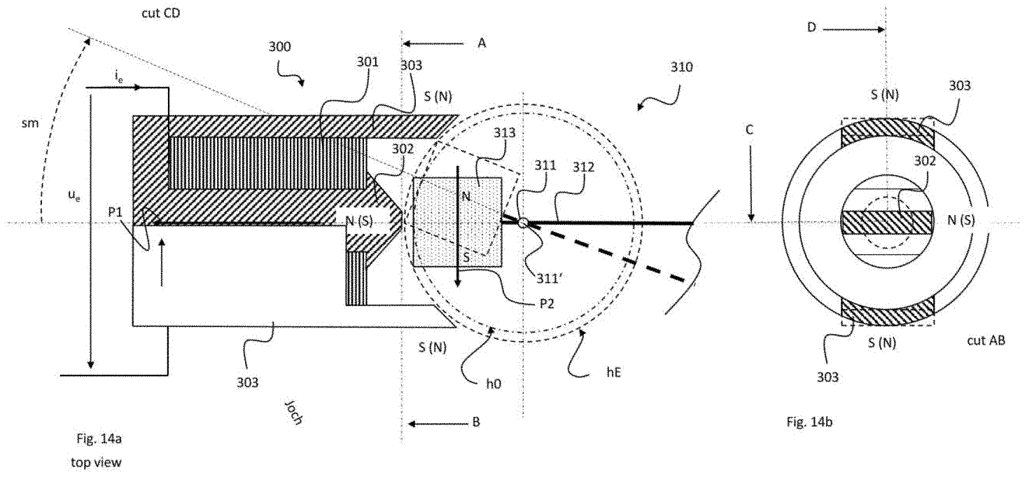

The core, comprising the central core of ferromagnetic material 302 and at least one lateral pole shoe or yoke of ferromagnetic material 303, can be formed as a flat E-shaped or U-shaped core or as a rotationally symmetrical cylindrically pot-shaped or as a cylindrically pot-shaped pole shoe or yoke of ferromagnetic material 303 cut out at the ends in each case, as shown for example in FIG. 14a and FIG. 14b.

FIG. 14a and FIG. 14b show an embodiment with a partially pot-shaped pole shoe or yoke made of ferromagnetic material 303, each as a sectional view, and FIG. 14a shows an embodiment in which the central core 302 and the lateral ends of the pole shoe or yoke made of ferromagnetic material 303 are designed in this embodiment such that the permanent magnet 313, during its rotation in the pendulum bearing 311 about the pendulum bearing axis of rotation 311′, passes through the circular arc-shaped distance lines h0 and he in such a way, in such a way that in its respective end position the permanent magnet assumes a respective minimum distance to the central core of ferromagnetic material 302 and to the pole shoe or yoke of ferromagnetic material 303 and in this position exerts the highest magnetic attractive force. Advantageously, the permanent magnet remains in this position even without an optionally possible mechanical stop until the reversing process (cf. FIG. 9a). The propulsion can thus be operated with particularly low noise.

FIG. 14b shows in cross section the ends of the central core of ferromagnetic material 302 forming the air gap and the ends of the pole shoe or yoke of ferromagnetic material 303. Advantageously, the cross section has a width corresponding to the shape of the magnetically effective edge of the permanent magnet.

The ends of a pot-shaped pole shoe or yoke made of ferromagnetic material 303 can optionally be embodied straight, for example to correspond with the straight edge of a cube- or cuboid-shaped permanent magnet 313. In the case of bar-shaped or cylindrical permanent magnets, the ends may each be embodied in an arcuate shape, so that in each of the aforementioned cases an air gap as homogeneous as possible is formed between the edge of the permanent magnet 313 and the central core of ferromagnetic material 302 and the pole shoe or yoke of ferromagnetic material 303. On the one hand, this achieves a high force effect of the permanent magnet 313 in the end positions and, on the other hand, a high magnetic flux density can be provided for reversing the pendulum lever 312.

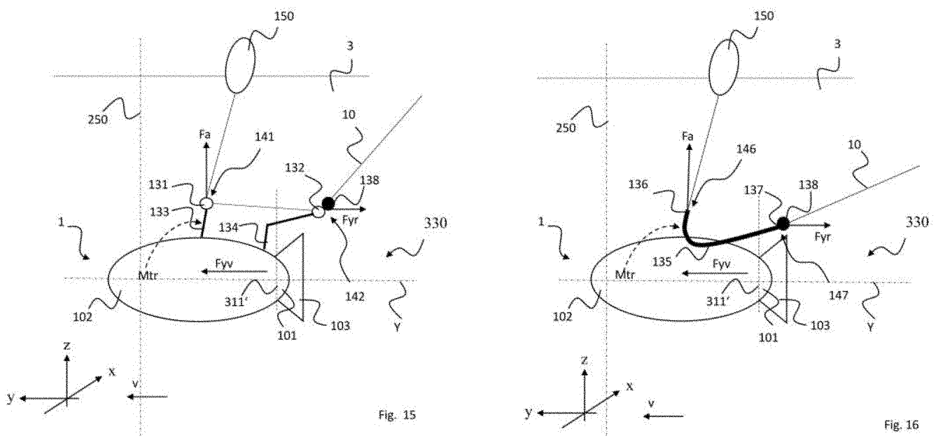

FIG. 15 shows an assembly example with line stopper with external line guide. As the mass of components such as the excitation coil 301 with the ferromagnetic components and the power source of the fishing bait 1 increases, the downward weight force on the fishing bait 1 increases. In order to compensate for this during the diving process of the fishing bait 1 in the surrounding water 3 so that the fishing bait 1 assumes a stable position in the surrounding water 3, a float 150 is advantageously attached to the bait body 102, which, on the one hand, statically determines the inclination of the bait body 102 and the diving depth in the surrounding water 3 and, on the other hand, indicates the current position of the fishing bait 1 to the angler at the surface of the surrounding water 3. In the embodiment shown, a line stopper 138 that is adjustable and lockable on the line is attached to the connecting line to the angler 10. The connecting line to the angler 10 is looped from behind by a rear second attachment means 132, which provides a rear second deviation point 142. The connecting line to the angler 10 is further looped through a front first attachment means 131, which provides a front first deviation point 141. From there, the connecting line to the angler 10 is further routed to the float 150 to the underside of which it is attached.

Due to the weight force, the fishing bait 1 initially slides down along the connecting line to the angler 10 in the surrounding water 3 until it reaches the position of the line stopper 138 at the rear second deviation point 142 of the rear second attachment means 132. A forward y-direction sum of force components Fyv generated by the fishing bait drive initially causes the fishing bait 1 to leave this position again, until the movement generated by the fishing bait drive over the portion of the connecting line to the angler 10 located between the fishing bait 1 and the float 150 causes the float 150 to move, thereby experiencing an upwardly directed force component Fa in balance with a downwardly directed weight force which pulls the line stopper 138 back to the rear second deviation point 142 of the rear second attachment means 132 on the bait body 102 and stabilizes the position of the fishing bait 1 on the connecting line to the angler 10 and thus the depth at which the fishing bait moves.

Optionally, the front first attachment means 131 is attached to a front first extension element 133. Advantageously, the front first extension element 133 comprises elastic deformable material, for example metal or plastic, and remains in the set shape until the next deformation. By these measures, the fishing bait 1 is statically trimmable in the inclination of the longitudinal axis of the bait body Y with respect to the plumb axis 250 in the surrounding water 3 in synergy with the weight force of the fishing bait drive and the components of the fishing bait 1 and is dynamically trimmable in its inclination with respect to the plumb axis 250 in synergy with the forward sum of force components Fyv generated by the fishing bait drive in the y-direction, and the fishing bait 1 is definably adjustable in its position in depth with respect to the surface of the surrounding water 3.

The connecting line to the angler 10 can be attached at any point on the bait body 102, depending on the desired lateral and/or forward movement v in the surrounding water 3. If a defined controllable forward movement v, directed away from the angler with natural course of motion of the bait body is to be achieved, the connecting line to the angler 10 is to be attached behind the drive point, preferably behind the pendulum bearing 311 or an auxiliary straight line, the pendulum bearing axis of rotation 311′, which runs axially inside the pendulum bearing 311.

In this example, the connecting line to the angler 10 is loopable from a float 150 through a front first attachment means 131 forming a front first deviation point 141 to a rear second attachment means 132 forming a rear second deviation point 142, where the connecting line to the angler 10 is limitable in its movement relative to the deviation points via a line stopper 138. Advantageously, the rear second deviation point 142 is arranged behind the pendulum pivot axis 311′ of the fishing bait drive.

In a preferred embodiment, the connecting line to the angler 10 is attached behind the pendulum pivot axis 311′ of the propulsion as viewed from the head end of the bait body.

FIG. 16 shows an assembly example with line stopper 138 corresponding to FIG. 15 with internal line guidance. Advantageously, in this embodiment, a connecting tube 135 is disposed within the bait body 102 through which the connecting line is looped to the angler 10 and whose rear second opening 137 forms a rear second deviation point 147 and whose front first opening 136 forms a front second deviation point 146.

In this embodiment, the connecting line to the angler 10 is loopable from a float 150 through a connecting tube 135 within the bait body 102.

It will be understood that the above description of preferred embodiments is exemplary only, and that various modifications may be embodied by those skilled in the art. Although various embodiments have been described above with some degree of precision, or with reference to one or more individual embodiments, those skilled in the art could make numerous modifications to the disclosed embodiments without departing from the essence or scope of protection of the present invention. Aspects of any of the examples described above may be combined with aspects of any other examples described to form further examples without losing any effect.

### LIST OF REFERENCE SIGNS

1 fishing bait
2 angler
3 surrounding water
10 connecting line to angler
11 fishing rod
12 rolling-up attachment
100 body shell
101 transition area of the tail fin
102 bait body
103 tail fin
104 rear outer wall of bait body
105 front outer wall of bait body
110 fishing hook
111 fishing hook reinforcement
120; 120′ rudder
121 right elevator
122 left elevator
130; 130′ attachment means
131 front first attachment means
132 rear second attachment means
133 front first extension element
134 rear second extension element
135 connecting tube
136 front first opening
137 rear second opening
138 line stopper
141 front first deviation point
142 rear second deviation point
146 front first deviation point
147 rear second deviation point
150 float
200 center of buoyancy
210 center of gravity
220 drive point
230 attachment point
250 plumb axis
300 electromagnet
301 excitation coil
302 core made of ferromagnetic material
303 pole shoe or yoke made of ferromagnetic material
304 first pole end
305 second pole end
310 pendulum actuator
311 pendulum bearing
311′ pendulum bearing pivot axis
312 pendulum lever
313 permanent magnet
314 elastic return element
330 tail-side propulsion
400 drive driver
410 electronic control unit
420 electrical power source
421 optional DC converter
422 manually operated control element
4301 ine sensor
431 acceleration sensor
440 artificial swim bladder
450 manually operated control actuator
460, 460′ interface
Y longitudinal axis of bait body
S magnetic south pole
N magnetic north pole
P1 first pole axis
P1′ further first pole axis
P2 second pole axis of the permanent magnet
sm deflection
h air gap
hi current air gap as a function of s
h0 air gap in zero position
hE air gap in end position
Mtr dynamic trim torque
Rp pendulum radius
L distance of pendulum bearing from electromagnet
Fm resulting magnetic force
Fmd magnetic force component transverse to pendulum lever
FmE resulting magnetic force in end position
Fr resetting force component
Mm magnetic moment of motion=Rp*Fmd
y optional direction of motion forward
x horizontal direction of motion right/left transverse to optional direction of motion
z vertical direction up/down transverse to optional direction of motion y
v velocity when moving in the direction of motion y, relative to surrounding water
Fyv forward in y-direction sum of force components at the point of attack
Fyr inertial force component at attachment point or rear second deviation point
ue electrical excitation voltage
ie. electrical excitation current

1.-18. (canceled)

19. An electromagnetic pendulum actuator, comprising:
an electric power source (420);
an electronic control unit (410);
an electromagnet (300) comprising an excitation coil (301) having a first pole axis (P1);
a pendulum actuator comprising a permanent magnet (313) having a second pole axis (P2) and a pendulum lever (312),
wherein due to a magnetic force field of the electromagnet (300) the permanent magnet (313) is movable transversely to a longitudinal axis of a body (Y),
wherein the excitation coil (301) is arranged with the first pole axis (P1) at an angle in the range of 0°+/−30° to the longitudinal axis of the body (Y).

20. The electromagnetic pendulum actuator of claim 19,
wherein the excitation coil (301) comprises a core of ferromagnetic material (302).

21. The electromagnetic pendulum actuator according to claim 20,
wherein a central core of ferromagnetic material (302)
is arranged inside the excitation coil (301) and
is guided via ferromagnetic material outside past the excitation coil (301) from a first pole end (304) of the central core of ferromagnetic material (302) to a second pole end (305) of the central core of ferromagnetic material (302) and
forms a pole shoe or yoke of ferromagnetic material (303) which at the second pole end (305) of the central core of ferromagnetic material (302) has an air gap to the central core of ferromagnetic material (302) in which the permanent magnet (313) is movably arranged in such a way that a projection of the first pole axis (P1) through the excitation coil (301) and the second pole axis (P2) through the permanent magnet (313) intersect in at least one position at a defined angle.

22. The electromagnetic pendulum actuator of claim 21,
wherein the pole shoe or yoke of ferromagnetic material (303) is formed U-shaped or E-shaped or is completely or at least partially pot-shaped.

23. The electromagnetic pendulum actuator according to claim 19,
wherein the permanent magnet (313) is arranged with the second pole axis (P2) relative to the longitudinal axis of the body (Y) within an angular range of 90°+/−40°.

24. The electromagnetic pendulum actuator according to claim 19,
wherein the permanent magnet (313) is arranged with the second pole axis (P2) relative to the longitudinal axis of the body (Y) within an angular range of 0°+/−40° and, in a zero position of the pendulum lever (312), intersects a projection of the first pole axis (P1) or the first pole axis (P1) is at a distance of not more than 5 mm from the second pole axis (P2) at an intersection of projections of the pole axes (P1, P2) relative to each other.

25. The electromagnetic pendulum actuator according to claim 19,
wherein driving of the electromagnet (300) comprises alternating polarity comprising an electrically bipolar AC voltage as driving voltage (ue) at the excitation coil (301) and a bipolar flowing AC current as excitation current (ie) through the excitation coil (301) of the electromagnet (300).

26. The electromagnetic pendulum actuator according to claim 25,
wherein a reversing operation of the pendulum lever (312) from an end position (smE+, smE−) is performed by an excitation current (ie) through the excitation coil (301) of the electromagnet (300),
wherein the excitation current (ie) is switched off or reduced when the pendulum lever (312) has reached a defined position between the end positions (smE+; smE−).

27. The electromagnetic pendulum actuator according to claim 25,
wherein means are arranged for detecting a position of the pendulum lever (312), said means causing the excitation current (ie) to be switched off or reduced via the electronic control unit (410).

28. The electromagnetic pendulum actuator according to claim 25,
wherein the excitation coil (301) of the electromagnet (300) is controlled via an electrical high-pass filter,
wherein dynamically high pulses of the excitation current (ie) can be generated in the excitation coil (301) of the electromagnet (300) and thereby an electrical charge taken from the electrical power source (420) can be limited.

29. The electromagnetic pendulum actuator according to claim 19,
wherein an air gap (h) is arranged between the electromagnet (300) and the permanent magnet (313), wherein the air gap (h) becoming smaller during a deflection (sm) of the pendulum lever (312) as a function of the deflection (sm) of the pendulum lever (312) from its zero position, reaching a minimum in an end position (smE+; smE−) and becomes larger when an end position (smE+; smE−) is exceeded.

30. An electromagnetic fishing bait drive comprising:
a bait body (102) which can be closed in a watertight manner and has a longitudinal axis of the bait body (Y), and
an electromagnetic pendulum actuator, comprising:
an electric power source (420);
an electronic control unit (410);
an electromagnet (300) comprising an excitation coil (301) having a first pole axis (P1);
a pendulum actuator comprising a permanent magnet (313) having a second pole axis (P2) and a pendulum lever (312),
wherein due to a magnetic force field of the electromagnet (300) the permanent magnet (313) is movable transversely to a longitudinal axis of the bait body (Y),
wherein the excitation coil (301) is arranged with the first pole axis (P1) at an angle in the range of 0°+/−30° to the longitudinal axis of the body (Y).

31. The electromagnetic fishing bait drive according to claim 30,
wherein a connecting line to an angler (10) is loopable from a float (150) through a front first attachment means (131) forming a front first deviation point (141) to a rear second attachment means (132) forming a rear second deviation point (142),
wherein the connecting line to the angler (10) is limitable in its movement relative to the deviation points (141, 142) via a line stopper (138).

32. The electromagnetic fishing bait drive of claim 31,
wherein the rear second deviation point (142) is located behind the pendulum pivot axis (311′) of the fishing bait drive.

33. The electromagnetic fishing bait drive of claim 31,
wherein a connecting line to the angler 10 is loopable from a float (150) through a connecting tube (135) within the bait body (102).

34. A method of controlling an electromagnetic fishing bait drive, comprising the steps of:
providing the electromagnetic fishing bait drive as in claim 30 in a body shell (100) of an artificial fishing bait or in a body shell (100) of a dead natural fishing bait;
attaching a connecting line to an angler and to the bait body (102) and/or the body shell (100);
producing an electrical joint from an electromagnetic power source (420) to electrical components of an electromagnetic pendulum drive; and
releasing the body shell (100) into a body of water (3).

35. The method of controlling an electromagnetic fishing bait drive according to claim 34 further comprising the steps of:
providing an electronic control unit (410) comprising a decoder within the bait body (102) or within the body shell (100),
providing a sensor for detecting drag force variations between the bait body (102) or the body shell (100) and a connecting line (10) to the angler (2) and/or speed variations of the bait body (102) or the body shell (100),
encoding a message by causing drag force variations on the connecting line (10) to the angler (2) by the angler and/or speed variations of the bait body (102) or the body shell (100) by causing drag force variations on the connecting line (10) to the angler (2) by the angler (2),
decoding the encoded message by the decoder in the bait body (102) or body shell (100),
performing a control action in response according to the decoded message by at least one control actuator and/or the electromagnetic pendulum drive.
